(19) United States
(12) Patent Application Publication
(10) Pub. No.: US 2025/0214363 A1
(43) Pub. Date: Jul. 3, 2025

(54) DISPLAY AND DISPLAY METHOD

(71) Applicant: TOPPAN INC., Tokyo (JP)

(72) Inventors: Masami INOKUCHI, Tokyo (JP); Daisuke SATO, Tokyo (JP); Naomichi MIMITA, Tokyo (JP)

(73) Assignee: TOPPAN INC., Tokyo (JP)

(21) Appl. No.: 19/086,969

(22) Filed: Mar. 21, 2025

Related U.S. Application Data
(63) Continuation of application No. 17/846,367, filed on Jun. 22, 2022.
Application No. 17/846,367 is a continuation of application No. PCT/JP2020/042929, filed on Nov. 18, 2020.

(30) Foreign Application Priority Data
Dec. 26, 2019 (JP) 2019-236260

(51) Int. Cl. B42D 25/328; B42D 25/24; B42D 25/351

(52) U.S. Cl. CPC B42D 25/328; B42D 25/24; B42D 25/351

(57) ABSTRACT

A display includes first and second portions and is deformable between a first state in which the portions are spaced apart from each other and a second state in which the portions overlap each other, wherein the first portion includes first and second regions each having a shape extending in a first direction and alternately and regularly arranged in a second direction, each of the first regions being a light-permeable region provided with a light-deflecting structure, and each of the second regions being a transparent region having flat front and back surfaces, and a latent image is recorded in the second portion, the latent image being identifiable or easy to identify when observed through the first portion in the second state.

### CROSS-REFERENCE TO RELATED APPLICATION

This application is a Continuation application of U.S. patent application Ser. No. 17/846,367, filed Jun. 22, 2022 which is a Continuation of PCT Application No. PCT/JP2020/042929, filed Nov. 18, 2020 and based upon and claiming the benefit of priority from prior Japanese Patent Application No. 2019-236260, filed Dec. 26, 2019, the entire contents of all of which are incorporated herein by reference.

### BACKGROUND

### 1. Field

Embodiments of the present invention relate to display technology.

### 2. Description of the Related Art

Securities, such as banknotes, stock certificates, gift certificates and tickets, which are composed of a carrier made of a polymer or paper and a printed layer provided on the carrier, have hitherto been provided with anti-counterfeiting measures.

For example, an optical element that is difficult to forge or duplicate may be formed on or affixed to a polymer carrier for anti-counterfeiting purposes. The optical element includes, for example, a hologram or a phosphor.

There is also an optical element that has a concavo-convex structure formed in a form of parallel lines on a thin metal film (see Patent Literature 1). Such an optical element has a so-called opal effect in which the shading and brightness derived from the concave-convex structure change when an observation angle is changed.

To prevent forgery of securities, printing may be used.

For example, when the carrier is made of paper, watermark printing may be used (see Patent Literature 2). Watermark printing uses transparent ink to print on a sheet and cause a difference in transmittance between a printed portion and a non-printed portion. When the sheet on which watermark printing has been performed is held up to light, the shading corresponding to the printing of characters, patterns, or the like is displayed.

Prior to the development of watermark printing, it was possible to form a watermark only at the time of papermaking, which had high effects on preventing forgery. However, as watermark printing using transparent ink has developed, it became easy to form a watermark. This has made it difficult to obtain a high anti-counterfeiting effect only with a watermark.

In some cases, a latent image is recorded in the form of parallel lines. Parallel lines can be formed by printing. Specifically, parallel lines are printed on the carrier such that the phases of the arrangements of the linear portions are shifted by half the pitch between one portion and another portion. These two portions are either indistinguishable or difficult to distinguish from each other when the printed material is observed with the unaided eye. When these parallel lines are overlaid with a filter made of a transparent film provided with parallel lines that have the same width of the linear portions and the same pitch of the arrangements of the linear portions as those of the aforementioned parallel lines, those two portions become distinguishable from each other due to the moiré effect.

In order to enhance the anti-counterfeiting effect, use of deformed parallel lines having uneven pitches, widths, and shapes of the line portions has also been suggested (see Patent Literature 1).

In the anti-counterfeiting technique using parallel lines, however, the authenticity cannot be determined without using a verification tool, that is, without using the above-described filter made of a transparent film provided with parallel lines.

For the anti-counterfeiting technique using parallel lines, it is suggested that determination of the authenticity can be made with only securities, that is, determination of the authenticity can be made without preparing a verification tool in advance (see Patent Literature 3). This suggestion is to record a latent image in the form of parallel lines on a portion of the securities and provide the other portion with a function as the above-described filter. The latent image becomes visible when the securities are folded such that these portions overlap each other.

### CITATION LIST

### Patent Literature

Patent Literature 1: Jpn. Pat. Appln. KOKAI Publication No. 2004-174880
Patent Literature 2: Jpn. Pat. Appln. KOKAI Publication No. 2000-290571
Patent Literature 3: Jpn. Pat. Appln. KOKAI Publication No. 2014-223731

### SUMMARY

In the above-described filter, the parallel lines serve as a light-shielding filter. Thus, in the above-described technique, it is difficult to brightly display a visual image obtained by visualizing a latent image.

Accordingly, an object of the present invention is to provide a technique that enables a visual image to be brightly displayed.

According to an aspect of the present invention, there is provided a display comprising a first portion and a second portion and being deformable between a first state in which the first portion and the second portion are spaced apart from each other and a second state in which the first portion and the second portion overlap each other, wherein the first portion includes first regions and second regions each having a shape extending in a first direction and alternately and regularly arranged in a second direction intersecting the first direction, each of the first regions being a light-permeable region provided with a light-deflecting structure having a light-deflecting property, and each of the second regions being a transparent region having a flat front surface and a flat back surface, and a latent image is recorded in the second portion, the latent image being unidentifiable or difficult to identify when observed without an intervention of the first portion in the first state and being identifiable or easy to identify when observed through the first portion in the second state.

Each of the first regions is provided with a light-deflecting structure having a light-deflecting property. For example, each of the first regions either has a light-scattering property or functions as a lenticule. Each of such first regions has a light-scattering property or a light-diffusing property. On the other hand, each of the second regions is a part of the transparent layer and has a flat front surface and a flat back surface. Specifically, each of the second regions is a transparent region having no light-scattering property or light-diffusing property. Thus, when a specular reflector is arranged on the back surface side of the first portion and is illuminated obliquely from the front, for example, the second regions allow light to emerge with a higher intensity than the first regions at an angle that enables observation of specular reflection light.

Thus, when the display is in the second state, for example, either moiré is generated due to an interference between the periodic structure formed by the second regions and the periodic structure provided in the second portion, or the second portion is partially hidden by the first region. As a result, an image is displayed which differs from an image recognized by an observer when the observer observes the image without the intervention of the first portion in the first state. Specifically, it is possible or easy to identify the latent image that is unidentifiable or difficult to identify when observed without the intervention of the first portion in the first state. In other words, the latent image is visualized.

In the display described above, the first regions correspond to a concealing filter. Each of the first regions has light permeability. Thus, the display can brightly display a visual image in the second state. Specifically, the first regions allow illumination light to pass therethrough while concealing a pattern on the back surface thereof.

According to another aspect of the present invention, there is provided a display according to the above aspect, wherein the light-deflecting structure includes a lenticule. Alternatively, According to another aspect of the present invention, there is provided a display according to the above aspect, wherein the light-deflecting structure includes a plurality of randomly arranged concave portions or convex portions. The light-deflecting structure may be any structure as long as it has the above-described function. Since this structure is a relief structure, it is suitable for production utilizing transfer.

According to a still another aspect of the present invention, there is provided a display according to any one of the above aspects, wherein the front surface and the back surface are parallel to each other. As will be understood later, the front and back surfaces may be parallel to each other or may be oriented differently. One surface and another surface being oriented differently means that the normal directions of these surfaces are different.

Alternatively, according to a still another aspect of the present invention, there is provided a display according to the above aspects, wherein the first portion includes a flat first main surface and a second main surface which is a back surface thereof, the second main surface being provided with a plurality of protrusions each having a shape extending in the first direction and regularly arranged in the second direction, a surface of each of the plurality of protrusions includes a first light-scattering surface and a first flat surface each having a shape extending in the first direction and arranged in the second direction, the first flat surface and the first light-scattering surface facing different directions from each other, and a region of the first portion corresponding to the first light-scattering surface is at least a part of the first region, and a region of the first portion corresponding to the first flat surface is at least a part of the second region.

Alternatively, according to a still another aspect of the present invention, there is provided a display comprising a first portion and a second portion and being deformable between a first state in which the first portion and the second portion are spaced apart from each other and a second state in which the first portion and the second portion overlap each other, wherein the first portion is made of a transparent material and includes a flat first main surface and a second main surface which is a back surface thereof, the second main surface is provided with a plurality of protrusions each having a shape extending in a first direction parallel to the second main surface and regularly arranged in a second direction parallel to the second main surface and intersecting the first direction, a surface of each of the plurality of protrusions includes a first light-scattering surface and a first flat surface each having a shape extending in the first direction and arranged in the second direction, and the first flat surface and the first light-scattering surface face different directions from each other, and a latent image is recorded in the second portion, the latent image being unidentifiable or difficult to identify when observed without an intervention of the first portion in the first state and being identifiable or easy to identify when observed through the first portion in the second state.

For example, when the display adopting the above-described configuration is inclined about an axis parallel to the first direction while the latent image is observed through the first portion in the second state, the ease of identification of the latent image changes. For example, when the inclination angle is a first angle, the latent image is unidentifiable or difficult to identify, and when the inclination angle is a second angle different from the first angle, the latent image is identifiable or easy to identify. Specifically, adopting the above-described configuration enables more complicated display.

According to a still another aspect of the present invention, there is provided a display according to any one of the above aspects, wherein an angle formed by the first flat surface with respect to a plane parallel to the first direction and the second direction is equal to an angle formed by the first light-scattering surface with respect to said plane. Alternatively, according to a still another aspect of the present invention, there is provided a display according to any one of the above aspects, wherein an angle formed by the first flat surface with respect to a plane parallel to the first direction and the second direction is different from an angle formed by the first light-scattering surface with respect to said plane. By adjusting these angles, it is possible to vary the range of the inclination angle that makes the latent image unidentifiable or difficult to identify or the range of the inclination angle that makes the latent image identifiable or easy to identify when the latent image is observed through the first portion in the second state.

According to a still another aspect of the present invention, there is provided a display according to any one of the above aspects, wherein each of the plurality of protrusions is a triangular prism having one side surface parallel to the first direction and the second direction and having a height direction parallel to the first direction, the first flat surface is another side surface of the triangular prism, and the first light-scattering surface is a remaining side surface of the triangular prism. Alternatively, according to a still another aspect of the present invention, there is provided a display according to any one of the above aspects, wherein each of the plurality of protrusions is a quadrangular prism having one side surface parallel to the first direction and the second direction and having a height direction parallel to the first direction, the first flat surface is another side surface of the quadrangular prism, and the first light-scattering surface is still another side surface of the quadrangular prism.

As described above, each of the protrusions is, for example, a polygonal column having one side surface parallel to the first direction and the second direction and a height direction parallel to the first direction. In this case, the first flat surface is another side surface of the polygonal column, and the first light-scattering surface is still another side surface of the polygonal column.

According to a still another aspect of the present invention, there is provided a display according to any one of the above aspects, wherein the plurality of protrusions are spaced apart from each other, and the second main surface includes second flat surfaces each located between two of the plurality of protrusions adjacent to each other. Alternatively, according to a still another aspect of the present invention, there is provided a display according to any one of the above aspects, wherein the plurality of protrusions are spaced apart from each other, and the second main surface includes second light-scattering surfaces each located between two of the plurality of protrusions adjacent to each other.

The plurality of protrusions adjacent to each other may be in contact with each other. When the plurality of protrusions are spaced apart from each other, the second main surface may have second flat surfaces or second light-scattering surfaces each located between two of the plurality of protrusions adjacent to each other, as described above.

According to a still another aspect of the present invention, there is provided a display according to any one of the above aspects, comprising a carrier made of a polymer.

A carrier made of a polymer is easily molded and easily provided with flexibility.

According to a still another aspect of the present invention, there is provided a display according to any one of the above aspects, wherein the first regions, the second regions, or the protrusions are arranged in a period within a range of 40 μm to 1000 μm. The period may be in a range of 50 μm to 1000 μm.

According to a still another aspect of the present invention, there is provided a display according to any one of the above aspects, wherein the second portion is formed of a plurality of band-shaped regions regularly arranged in a width direction, and the latent image is recorded in the plurality of band-shaped regions.

According to a still another aspect of the present invention, there is provided a display according to the above aspect, wherein the second portion includes first and second display portions adjacent to each other, one or more of the plurality of band-shaped regions each include first to fourth sub-regions, and in each of the one or more of the plurality of band-shaped regions, each of the first and second sub-regions displays a first color, each of the third and fourth sub-regions displays a second color different from the first color, the first and third sub-regions are arranged in the width direction in the first display portion, the second and fourth sub-regions are arranged in the width direction in the second display portion, and the first and second sub-regions are at different positions in the width direction.

Alternatively, according to a still another aspect of the present invention, there is provided a display according to the above aspect, wherein the second portion includes first and second display portions adjacent to each other, one or more of the plurality of band-shaped regions each include first to sixth sub-regions, and in each of the one or more of the plurality of band-shaped regions, each of the first and second sub-regions displays a first color, each of the third and fourth sub-regions displays a second color different from the first color, each of the fifth and sixth sub-regions displays a third color different from the first and second colors, the first, third, and fifth sub-regions are arranged in the width direction in the first display portion, the second, fourth, and sixth sub-regions are arranged in the width direction in the second display portion, the first and second sub-regions are at different positions in the width direction, the third and fourth sub-regions are at different positions in the width direction, and the fifth and sixth sub-regions are at different positions in the width direction.

According to these configurations, the first and second display portions can, for example, be made indistinguishable from each other when observed with the unaided eye in the first state, and distinguishable from each other when observed with the unaided eye in the second state. Specifically, a latent image corresponding to one of the first and second display portions can be recorded.

According to a still another aspect of the present invention, there is provided a display according to the above aspect, wherein in each of the one or more of the plurality of band-shaped regions, all of the first, third, and fifth sub-regions are at a position different from the positions of the second, fourth, and sixth sub-regions in the width direction.

Alternatively, according to a still another aspect of the present invention, there is provided a display according to the above aspect, wherein in each of the one or more of the plurality of band-shaped regions, the first and fourth sub-regions are at a same position in the width direction, the second and fifth sub-regions are at a same position in the width direction, and the third and sixth sub-regions are at a same position in the width direction.

In this manner, various arrangements are possible for the sub-regions.

According to a still another aspect of the present invention, there is provided a display according to any one of the above aspects, wherein the first regions or the protrusions are arranged in a first period P1, the plurality of band-shaped regions are arranged in a second period P2, and a ratio P1/P2 of the first period P1 to the second period P2 is an integer. This configuration is suitable for visualizing the latent image described above.

Alternatively, according to a still another aspect of the present invention, there is provided a display according to any one of the above aspects, wherein the first regions or the protrusions are arranged in a first period P1, the plurality of band-shaped regions are arranged in a second period, and a ratio P1/P2 of the first period P1 to the second period P2 is deviated from integers. This configuration is suitable when a combination of the band-shaped regions and the first and second regions, for example, displays in the second state an image having the same shape as that of an image obtained by expanding an image recorded in each band-shaped region in the width direction. This configuration is also suitable for visualizing the latent image described above. When this configuration is adopted, a ratio (P1−P2)/P2 of a difference between the first period P1 and the second period P2 to the second period P2 can be set in a range of −0.25 to −0.10. The ratio may also be set in a range of 0.10 to 0.25.

According to a still another aspect of the present invention, there is provided a display according to any one of the above aspects, wherein the display has a rectangular shape, and both the second direction and the width direction are parallel to or perpendicular to a long side of the display. Alternatively, according to a still another aspect of the present invention, there is provided a display according to any one of the above aspects, wherein the display has a rectangular shape, and both the second direction and the width direction are inclined with respect to a long side of the display. When the display has a rectangular shape, any one of these configurations may be adopted.

According to a still another aspect of the present invention, there is provided a display according to any one of the above aspects, wherein the display is in a sheet form or a film form, the first state is a state in which the display is unfolded, and the second state is a state in which the display is folded or bent.

The shape of the display is not limited; however, if it is in the form of a sheet or a film, it has a wide range of applications. For example, a display in the form of a sheet or a film can be used as securities such as banknotes, stock certificates, gift certificates and tickets. When the display is in the form of a sheet or a film, the latent image can be visualized by a simple operation of folding or bending the display.

According to a still another aspect of the present invention, there is provided a display according to any one of the above aspects, wherein the display has a rectangular shape, and the first and second portions are arranged to be in the second state when the display is folded or bent such that an edge along one short side overlaps an edge along another short side.

Such an arrangement makes it possible to easily align the first and second portions with respect to each other with high accuracy when deforming the display from the first portion to the second portion.

According to a still another aspect of the present invention, there is provided a display according to any one of the above aspects, wherein the display is a booklet.

Even when the display is in the form of a booklet, it has a wide range of application. The display in the form of a booklet can be used, for example, as a passport or a passbook such as a deposit passbook. For example, when the display is in the form of a booklet, the first portion is one of two page portions that overlap each other with the booklet closed or a part of said page portion, and the second portion is those two page portions or a part thereof. The “page portion” herein refers to a portion corresponding to a page on the front side and a page on the back side of a sheet constituting the booklet.

Specifically, the “page portion” is a portion having one page allocated to one surface of a sheet constituting the booklet and another page allocated to the other surface of the sheet constituting the booklet. For example, if the booklet includes a sheet folded in two, each of the two separate portions of the sheet created by the folding line is the “page portion”. The first state is, for example, a state in which the booklet is opened such that the page portion including the first portion and the page portion including the second portion are spaced apart from each other. The second state is, for example, a state in which the booklet is opened such that the page portion including the first portion is exposed and positioned on the page including the second portion. According to this configuration, the latent image can be visualized by a simple operation of turning pages.

According to a still another aspect of the present invention, there is provided a display according to any one of the above aspects, wherein the latent image is recorded as print on the second portion. The latent image may be recorded by a method other than printing, but printing makes it easy to form the latent image.

According to a still another aspect of the present invention, there is provided a display method comprising causing the display according to any one of the above aspects to be in the second state. According to this method, it is unnecessary to separately prepare a verification tool. Also, it is possible to brightly display the visual image in the second state.

### BRIEF DESCRIPTION OF THE DRAWINGS

FIG. 1 is a plan view schematically showing a structure of a display according to a first embodiment of the present invention in a first state.

FIG. 2 is a cross-sectional view schematically showing an example of a structure that can be adopted for a first portion included in the display shown in FIG. 1.

FIG. 3 is a cross-sectional view schematically showing an example of an embossing cylinder that can be used for manufacturing the display adopting the structure shown in FIG. 2 for the first portion.

FIG. 4 is a cross-sectional view schematically showing a manufacturing process of a mother plate used for manufacturing the embossing cylinder shown in FIG. 3.

FIG. 5 is a cross-sectional view schematically showing another manufacturing process of the mother plate used for manufacturing the embossing cylinder shown in FIG. 3.

FIG. 6 is a cross-sectional view schematically showing another example of a structure that can be adopted for the first portion included in the display shown in FIG. 1.

FIG. 7 is a cross-sectional view schematically showing an example of an embossing cylinder that can be used for manufacturing the display adopting the structure shown in FIG. 6 for the first portion.

FIG. 8 is a cross-sectional view schematically showing a manufacturing process of a mother plate used for manufacturing the embossing cylinder shown in FIG. 7.

FIG. 9 is a cross-sectional view schematically showing an example of a structure that can be adopted for a second portion of the display shown in FIG. 1.

FIG. 10 is a plan view schematically showing the structure of the display shown in FIG. 1 in a second state.

FIG. 11 is an enlarged cross-sectional view of a portion of the structure shown in FIG. 10.

FIG. 12 is an enlarged cross-sectional view of another portion of the structure shown in FIG. 10.

FIG. 13 is a plan view schematically showing an example of a structure that can be adopted for the first portion.

FIG. 14 is a plan view schematically showing an example of a structure that can be adopted for the second portion.

FIG. 15 is a plan view schematically showing a state in which the first portion shown in FIG. 13 and the second portion shown in FIG. 14 are overlapped with each other.

FIG. 16 is a plan view schematically showing an example of an image displayed in the first state by the display adopting the structures shown in FIGS. 13 and 14 for the first and second portions, respectively.

FIG. 17 is a plan view schematically showing an example of an image displayed in the second state by the display adopting the structures shown in FIGS. 13 and 14 for the first and second portions, respectively.

FIG. 18 is a plan view schematically showing an example of a structure that can be adopted for a first portion in a display according to a second embodiment of the present invention.

FIG. 19 is a plan view schematically showing an example of a structure that can be adopted for a second portion in the display according to the second embodiment of the present invention.

FIG. 20 is a plan view schematically showing a state in which the first portion shown in FIG. 18 and the second portion shown in FIG. 19 are overlapped with each other.

FIG. 21 is a plan view schematically showing an example of a structure that can be adopted for a second portion in a display according to a third embodiment of the present invention.

FIG. 22 is a plan view schematically showing a state in which the first portion shown in FIG. 18 and the second portion shown in FIG. 21 are overlapped with each other.

FIG. 23 is a plan view schematically showing an example of a structure that can be adopted for a first portion in a display according to a fourth embodiment of the present invention.

FIG. 24 is a plan view schematically showing an example of a structure that can be adopted for a second portion in the display according to the fourth embodiment of the present invention.

FIG. 25 is a plan view schematically showing a state in which the first portion shown in FIG. 23 and the second portion shown in FIG. 24 are overlapped with each other.

FIG. 26 is a partially cut-away perspective view schematically showing a display according to a fifth embodiment of the present invention.

FIG. 27 is another partially cut-away perspective view of the display shown in FIG. 26.

FIG. 28 is a diagram schematically showing a state in which an observer observes the display shown in FIGS. 26 and 27.

FIG. 29 is a diagram showing an example of an image displayed in the second state by the display shown in FIGS. 26 and 27.

FIG. 30 is a diagram showing another example of an image displayed in the second state by the display shown in FIGS. 26 and 27.

FIG. 31 is a partially cut-away perspective view schematically showing an example of a structure that can be adopted for a first portion in a display according to a sixth embodiment of the present invention.

FIG. 32 is another partially cut-away perspective view of the structure shown in FIG. 31.

FIG. 33 is a cross-sectional view schematically showing an example of a structure that can be adopted for a first portion in a display according to a seventh embodiment of the present invention.

FIG. 34 is a cross-sectional view schematically showing an example of a structure that can be adopted for a first portion in a display according to an eighth embodiment of the present invention.

FIG. 35 is a cross-sectional view schematically showing an example of a structure that can be adopted for a first portion in a display according to a ninth embodiment of the present invention.

FIG. 36 is a plan view schematically showing a display according to a tenth embodiment of the present invention.

### DETAILED DESCRIPTION

Hereinafter, embodiments of the present invention will be described with reference to the accompanying drawings. The embodiments described below are more specific examples of any of the above aspects. Elements having the same or similar functions are denoted by the same reference numerals, and a repeat description thereof will be omitted.

### First Embodiment

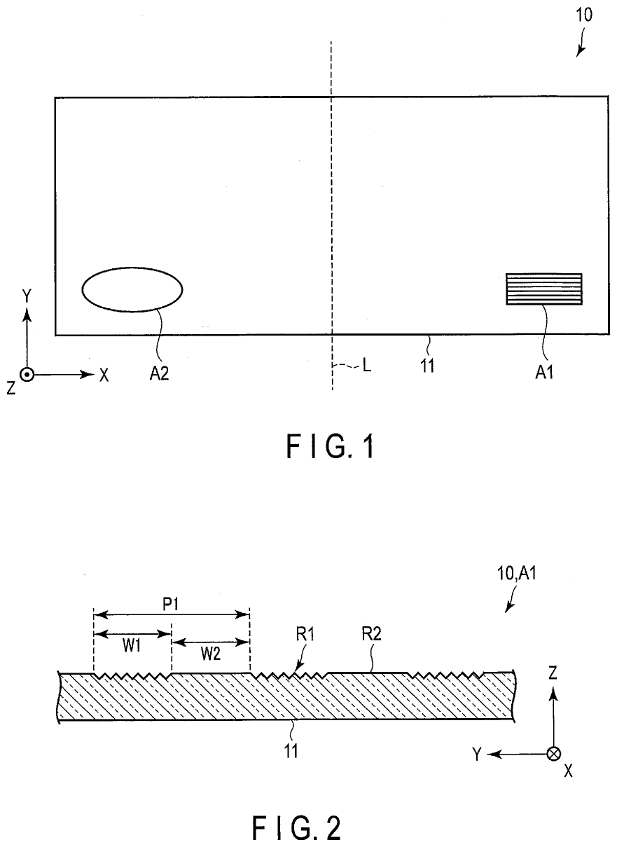

FIG. 1 is a plan view schematically showing a structure of a display according to a first embodiment of the present invention in a first state.

A display 10 shown in FIG. 1 is a rectangular sheet or film. In the drawing, an X direction is a direction parallel to the long sides of the display 10, a Y direction is a direction parallel to the short sides of the display 10, and a Z direction is a thickness direction of the display 10, that is, a direction perpendicular to the X direction and the Y direction.

The display 10 includes a carrier 11. The carrier 11 can be a sheet or a film. The carrier 11 can be a plastic sheet or a plastic film. The outer shape of the carrier 11 can be rectangular.

The thickness of the carrier 11 is preferably in a range of 0.05 mm to 0.3 mm. If the thickness is smaller than this, wrinkles are easily generated. If the thickness is larger than this, bending becomes difficult.

The length of the short sides of the carrier 11 is preferably in a range of 50 mm to 100 mm. If the short sides are short, it is difficult to form a pattern. If the short sides are long, it is difficult to carry the display 10.

The length of the long sides of the carrier 11 is preferably in a range of 125 mm to 200 mm. In this range, it is easy to bend the carrier 11.

The aspect ratio of the carrier 11 is preferably in a range of 1:1.5 to 1:3. If the aspect ratio is in this range, it is easy to bend the display 10.

The material of the carrier 11 can be a thermoplastic resin. A thermoplastic resin is less likely to cause a crack defect when the carrier 11 is bent. Examples of the thermoplastic resin include: photocurable resins such as biaxially oriented polypropylene (BOPP), polycarbonate resins, acrylic resins, fluorine-based acrylic resins, silicone-based acrylic resins, epoxyacrylate resins, polystyrene resins, cycloolefin polymers, methylstyrene resins, fluorene resins, polyethylene terephthalate (PET), and polypropylene; thermosetting resins such as acrylonitrile-styrene copolymer resins, phenol resins, melamine resins, urea resins, and alkyd resins; and thermoplastic resins such as polypropylene resins, polyethylene terephthalate resins, and polyacetal resins.

Alternatively, the carrier 11 may be made of a thermosetting resin such as a urethane resin, a melamine resin, an epoxy resin, a phenol resin, a mixture thereof, or a copolymer thereof.

Alternatively, the carrier 11 may be made of an ultraviolet curable resin such as urethane acrylate, acrylic resin acrylate, or epoxy acrylate.

The carrier 11 is provided with a first portion A1 and a second portion A2. The first portion A1 and the second portion A2 are symmetrical with respect to a straight line L that is parallel to the short sides of the carrier 11 and bisects the carrier 11. When the display 10 is bisected at the straight line L and folded, the first portion A1 and the second portion A2 preferably overlap each other at a position within ⅓ of the distance from an edge on the short side to the straight line L.

FIG. 2 is a cross-sectional view schematically showing an example of a structure that can be adopted for the first portion included in the display shown in FIG. 1.

The first portion A1 shown in FIG. 2 includes first regions R1 and second regions R2. The first regions R1 and the second regions R2 each have a shape extending in a first direction, the X direction in this figure. The first regions R1 and the second regions R2 are alternately and regularly arranged in a second direction, the Y direction in this figure, intersecting the first direction.

Each of the first regions R1 has a light-scattering property. Herein, each of the first regions R1 has randomly arranged concave portions or convex portions on one surface. Each of the first regions R1 has a width W1. The first regions R1 are arranged in a first period P1 in the Y direction.

Each of the second regions R2 is a transparent region having a flat front surface and a flat back surface. The front and back surfaces are parallel to each other. Each of the second regions R2 has a width W2. The second regions R2 are arranged in the first period P1 in the Y direction.

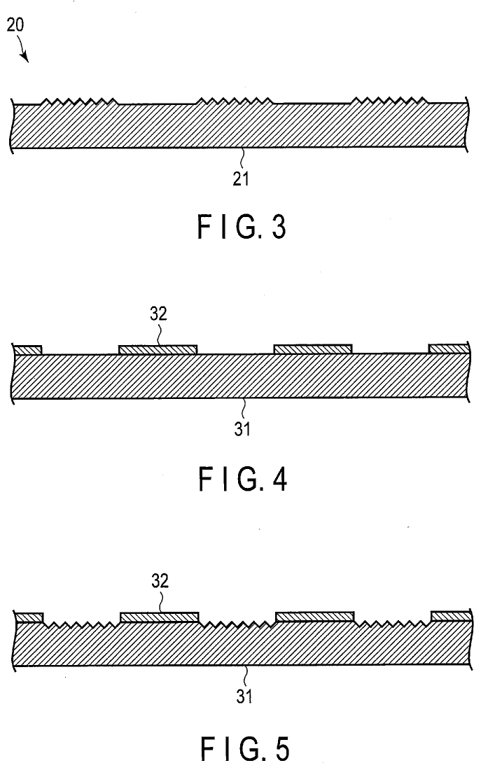

FIG. 3 is a cross-sectional view schematically showing an example of an embossing cylinder that can be used for manufacturing the display adopting the structure shown in FIG. 2 for the first portion. FIG. 3 shows only a part of the embossing cylinder.

The embossing cylinder 20 shown in FIG. 3 has a metal substrate 21 having a cylindrical shape. The cylindrical surface of the metal substrate 21 has convex portions or concave portions corresponding to the concave portions or convex portions of the first regions R1. The carrier 11 shown in FIG. 2 can be manufactured, for example, by transfer using the embossing cylinder 20.

FIG. 4 is a cross-sectional view schematically showing a manufacturing process of a mother plate used for manufacturing the embossing cylinder shown in FIG. 3. FIG. 5 is a cross-sectional view schematically showing another manufacturing process of the mother plate used for manufacturing the embossing cylinder shown in FIG. 3.

The mother plate used for manufacturing the embossing cylinder 20 shown in FIG. 3 is manufactured, for example, by the method described below.

First, a mask layer 32 is formed on a main surface of a mold substrate 31, as shown in FIG. 4. A pattern corresponding to the second regions R2 and a portion other than the first portion A1 is formed in the mask layer 32.

The mask layer 32 is obtained by, for example, applying a photoresist to the main surface of the mold substrate 31, partially exposing the photoresist layer, and then developing the photoresist layer. Alternatively, the mask layer 32 is formed by, for example, printing ink on the main surface of the mold substrate 31.

This high-definition printing is, for example, silk-screen printing or gravure offset printing. Gravure offset printing makes it easier to achieve higher definition than other printing techniques. Gravure printing and offset printing can also be employed as the high-definition printing.

For example, one or a mixture of two or more selected from the following can be used as the varnish (vehicle) constituting the ink: polyolefin resins such as polyethylene resins and polypropylene chloride resins; poly(meth)acrylic resins; polyvinyl chloride resins; polyvinyl acetate resins; vinyl chloride-vinyl acetate copolymers; polystyrene resins; styrene-butadiene copolymers; vinylidene fluoride resins; polyvinyl alcohol resins; polyvinyl acetal resins; polyvinyl butyral resins; polybutadiene resins; polyester resins; polyamide resins; alkyd resins; epoxy resins; unsaturated polyester resins; thermosetting poly(meth)acrylic resins; melamine resins; urea resins; polyurethane resins; phenol resins; xylene resins; maleic acid resins; cellulose resins such as nitrocellulose, ethylcellulose, acetylbutylcellulose and ethyloxyethylcellulose; rubber resins such as chlorinated rubber and cyclized rubber; petroleum resins; natural resins such as rosin and casein; oils such as linseed oil and soybean oil; and other resins. The varnish can discretionarily contain one or more selected from coloring agents such as dyes and pigments, fillers, stabilizers, plasticizers, antioxidants, light stabilizers such as ultraviolet absorbers, dispersants, thickneners, drying agents, lubricants, antistatic agents, cross-linking agents, and other additives. The ink is obtained by sufficiently mixing these materials with a solvent, a diluent or the like.

Next, the main surface of the mold substrate 31 is chemically etched or physically etched. For example, the main surface is subjected to chemical corrosion, electrolytic corrosion, scraping, wire brushing, sandblasting, or liquid honing. Alternatively, the main surface is, for example, electroplated. The electroplating can be performed by a dispersion plating method.

Thereafter, the mask layer 32 is removed from the main surface. Through the above process, the mother plate is obtained. The embossing cylinder 20 shown in FIG. 3 is obtained by, for example, fixing the mother plate to a cylinder.

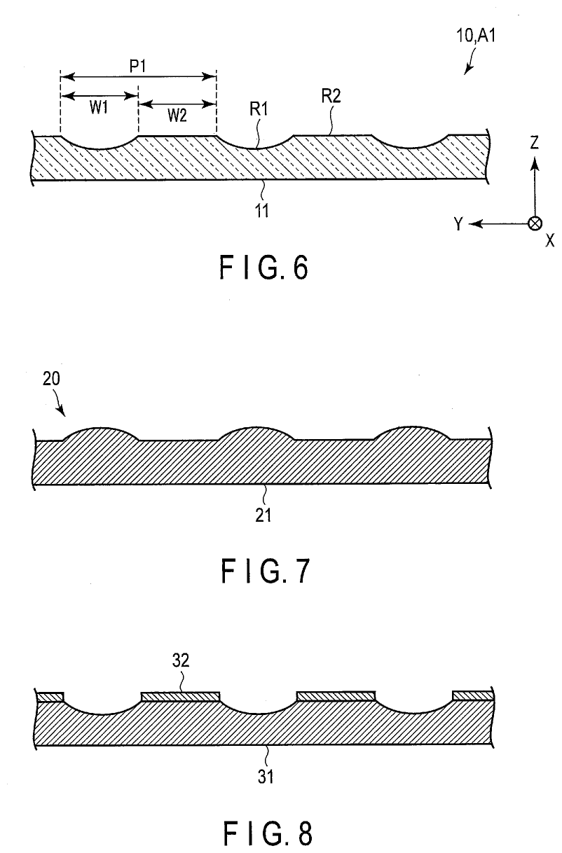

FIG. 6 is a cross-sectional view schematically showing another example of a structure that can be adopted for the first portion included in the display shown in FIG. 1.

In the first portion A1 shown in FIG. 6, the first regions R1 function as a lenticule extending in the longitudinal direction of the first regions R1. Other than this, the first portion A1 shown in FIG. 6 is the same as the first portion A1 described with reference to FIG. 2, etc.

FIG. 7 is a cross-sectional view schematically showing an example of an embossing cylinder that can be used for manufacturing the display adopting the structure shown in FIG. 6 for the first portion.

The embossing cylinder 20 shown in FIG. 7 is the same as the embossing cylinder 20 described with reference to FIG. 3, etc., except that convex portions corresponding to lenticules are provided on the cylindrical surface of the metal substrate 21 at the positions corresponding to the first regions R1. The carrier 11 adopting the structure shown in FIG. 6 for the first portion A1 can be manufactured, for example, by transfer using this embossing cylinder 20.

FIG. 8 is a cross-sectional view schematically showing a manufacturing process of a mother plate used for manufacturing the embossing cylinder shown in FIG. 7.

For example, to manufacture the mother plate, the mask layer 32 is formed on the main surface of the mold substrate 31 first, as described with reference to FIG. 4. The main surface is then chemically etched or physically etched. Thereafter, the mask layer 32 is removed from the mold substrate 31. Through the above process, the mother plate is obtained.

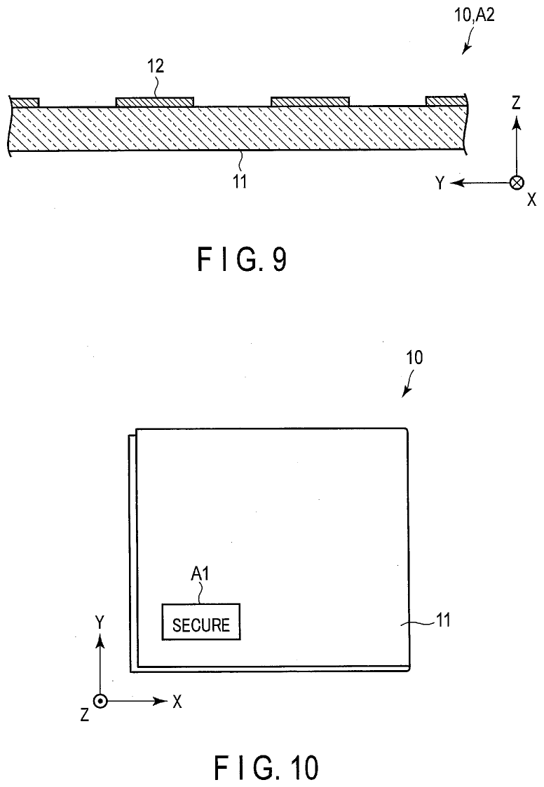

FIG. 9 is a cross-sectional view schematically showing an example of a structure that can be adopted for the second portion of the display shown in FIG. 1.

In the second portion A2 shown in FIG. 9, a printed layer 12 is provided on the carrier 11. The printed layer 12 is formed by, for example, inkjet printing or laser printing.

The printed layer 12 forms a plurality of parallel lines. The lines constituting the parallel lines are parallel to the X direction and are arranged in the Y direction. These parallel lines have the same width of the linear portions and the same pitch of the arrangements of the linear portions. The phases of the arrangements of the linear portions of the adjacent parallel lines are shifted. These parallel lines form a latent image that is unidentifiable or difficult to identify when observed with the unaided eye without the intervention of the first portion.

Herein, it is assumed that the printed layer 12 forms two parallel lines, as an example. A part of the second portion A2 corresponding to one of these two parallel lines and a part of the second portion A2 corresponding to the other of these two parallel lines correspond to a first display portion DP1 and a second display portion DP2 (described later), respectively. Herein, the printed layer 12 is made of black ink, as an example.

The parallel lines may be formed by laser engraving instead of being formed of the printed layer 12. In this case, a carrier containing a thermosensitive coloring agent, for example, may be used as the carrier 11. Also, if the carrier 11 is a plastic film, the plastic of the carrier 11 can be partially carbonized to form the parallel lines.

FIG. 10 is a plan view schematically showing a structure of the display shown in FIG. 1 in the second state.

The display 10 shown in FIG. 10 is obtained by folding the display 10 shown in FIG. 1 in two at the position of the straight line L as a folding line. When the display 10 is folded in this manner, the first portion A1 and the second portion A2 overlap each other, and the second portion A2 can be observed through the first portion A1. In this state, the latent image is identifiable or easy to identify. That is, the latent image is visualized. In FIG. 10, a character string “SECURE” is shown as the visual image.

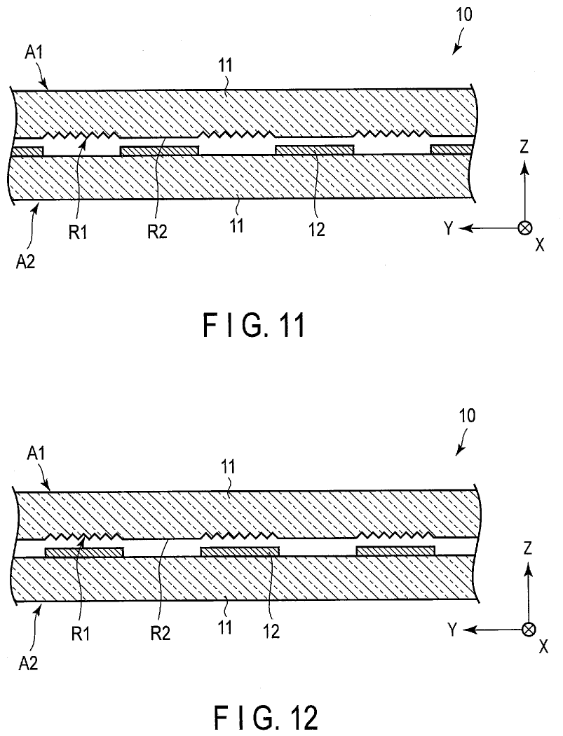

The mechanism by which the latent image is visualized will be described with reference to FIGS. 11 and 12.

FIG. 11 is an enlarged cross-sectional view of a portion of the structure shown in FIG. 10. FIG. 12 is an enlarged cross-sectional view of another portion of the structure shown in FIG. 10.

FIG. 11 shows a portion corresponding to one of the above-described two parallel lines of the structure shown in FIG. 10. FIG. 12 shows a portion corresponding to the other of the above-described two parallel lines of the structure shown in FIG. 10.

In FIG. 11, the first regions R1 face the openings of the printed layer 12, and the second regions R2 face the parallel lines formed by the printed layer 12. On the other hand, in FIG. 12, the first regions R1 face the parallel lines formed by the printed layer 12, and the second regions R2 face the openings of the printed layer 12.

As described above, the first regions R1 have a light-scattering property, and the second regions R2 are transparent regions. Thus, when the structure shown in FIGS. 10 to 12 is placed on a white base such that the second portion A2 is positioned between the base and the first portion A1, and the first portion A1 is illuminated obliquely from above and observed at an angle that enables observation of specular reflection light, for example, the portion shown in FIG. 12 appears to have a different color from that of the portion shown in FIG. 11. For example, the portion shown in FIG. 12 appears brighter than the portion shown in FIG. 11. In this manner, the latent image is visualized.

In addition, the first regions R1 have light permeability. Thus, the visual image can be displayed more brightly, as compared to a case where the first regions R1 include, for example, a black printed layer.

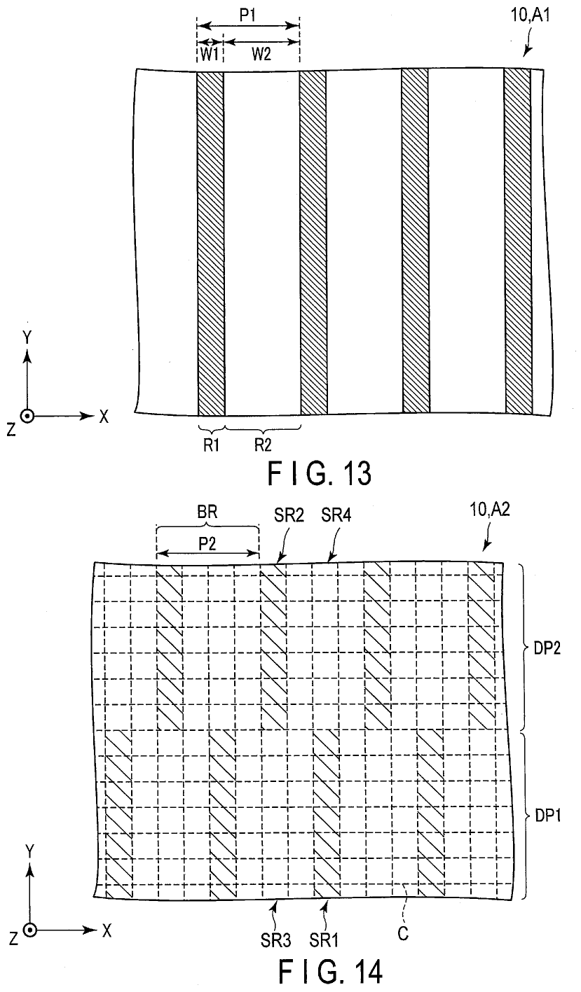

The above visualization will be further described with reference to FIGS. 13 to 17.

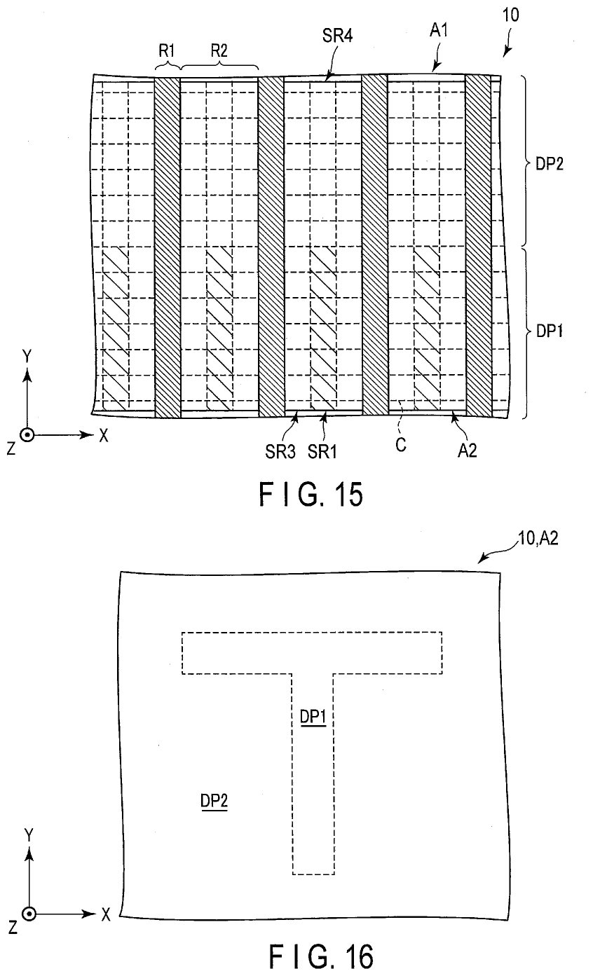

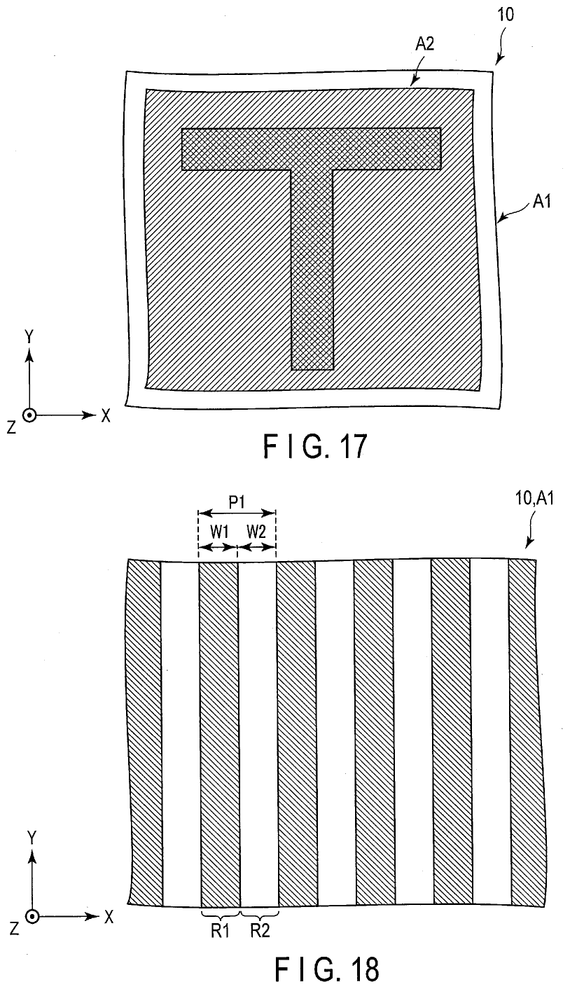

FIG. 13 is a plan view schematically showing an example of a structure that can be adopted for the first portion. FIG. 14 is a plan view schematically showing an example of a structure that can be adopted for the second portion. FIG. 15 is a plan view schematically showing a state in which the first portion shown in FIG. 13 and the second portion shown in FIG. 14 are overlapped with each other. FIG. 16 is a plan view schematically showing an example of an image displayed in the first state by the display that adopts the structures shown in FIGS. 13 and 14 for the first and second portions, respectively. FIG. 17 is a plan view schematically showing an example of an image displayed in the second state by the display that adopts the structures shown in FIGS. 13 and 14 for the first and second portions, respectively.

In the first portion A1 shown in FIG. 13, the first regions R1 each extend in the Y direction and are arranged in the X direction. The first regions R1 or the second regions R2 are arranged in the first period P1. The ratio W1/W2 between the width W1 of the first region R1 and the width W2 of the second region R2 is 1/3.

The second portion A2 shown in FIG. 14 is constituted by a plurality of band-shaped regions BR each extending in the Y direction and arranged in the X direction. The band-shaped regions BR are arranged in the second period P2. The ratio P1/P2 of the first period P1 to the second period P2 is 1.

The second portion A2 includes the first display portion DP1 and the second display portion DP2 adjacent to each other. Either the first display portion DP1 or the second display portion DP2 forms a latent image.

Each band-shaped region BR includes a plurality of cells C arranged in the X direction and the Y direction. Some of the cells C display the first color and the rest of the cells C display the second color different from the first color. The portion displaying the first color corresponds to the portion where the printed layer 12 is provided. According to one example, the first color is black and the second color is white. The first color and the second color can be chromatic or achromatic.

Each of the portions of the printed layer 12 corresponding to the cells C displaying the first color has, for example, a circular shape or a quadrangular shape. Each of the portions of the printed layer 12 corresponding to the cells C displaying the first color may have an elliptical shape or a rectangular shape. All or some of the portions corresponding to the cells C displaying the first color may have the same shape and the same size, or all or some of the portions corresponding to the cells C displaying the first color may have different shapes or different sizes, or have different shapes and sizes. The size of these portions or the pitch of the arrangement of the cells C is, for example, in a range of 5 μm to 500 μm. If the pitch is too small, that is, smaller than 5 μm, it becomes difficult to align the first portion A1 with the second portion A2. If the pitch is 5 μm or more, the first display portion DP1 and the second display portion DP2 are easily distinguished from each other in the first state. If the pitch is 500 μm or less, the deterioration of an image displayed by the cells C is hard to recognize.

One or more of the band-shaped regions BR includes sub-regions SR1 to SR4. The sub-regions SR1 and SR2 are first and second sub-regions, respectively, and each displays the first color. The sub-regions SR3 and SR4 are third and fourth sub-regions, respectively, and each displays the second color. The widths of the sub-regions SR1 and SR2 are equal to the widths W1 of the first regions R1.

In each of the band-shaped regions BR including the sub-regions SR1 to SR4, the sub-regions SR1 and SR3 are arranged in the width direction in the first display portion DP1, the sub-regions SR2 and SR4 are arranged in the width direction in the second display portion DP2, and the positions of the sub-regions SR1 and SR2 in the width direction differ from each other. Herein, the positions of the sub-regions SR1 and SR2 in the width direction are shifted with respect to each other by half of the second period P2. This shift is so small that it is impossible or difficult to distinguish the first display portion DP1 and the second display portion DP2 from each other when the second portion A2 is observed with the unaided eye without the intervention of the first portion A1.

One or more of the band-shaped regions BR may include only the sub-regions SR1 and SR3. Specifically, one or more of the band-shaped regions BR may be entirely located in the first display portion DP1. Likewise, one or more of the band-shaped regions BR may include only the sub-regions SR2 and SR4. Specifically, one or more of the band-shaped regions BR may be entirely located in the second display portion DP2.

When the first portion A1 and the second portion A2 are overlapped with each other such that the first regions R1 face the sub-regions SR2, as shown in FIG. 15, a difference occurs between the influence of the sub-regions SR1 and SR3 on the display at the position of the first display portion DP1 and the influence of the sub-regions SR2 and SR4 on the display at the position of the second display portion DP2. As a result, the latent image is visualized.

For example, when the second portion A2 is observed with the unaided eye without the intervention of the first portion A1, the first display portion DP1 and the second display portion DP2 appear to have the same color, as shown in FIG. 16, and are indistinguishable or difficult to distinguish from each other. In contrast, when the second portion A2 is observed with the unaided eye through the first portion A1, the first display portion DP1 and the second display portion DP2 appear to have different colors, as shown in FIG. 17. Therefore, the first display portion DP1 and the second display portion DP2 can be easily distinguished from each other.

The color of the colored sub-region of the band-shaped region BR may not be black or white. The color of the colored sub-region may be, for example, one or more of cyan, yellow, and magenta.

### Second Embodiment

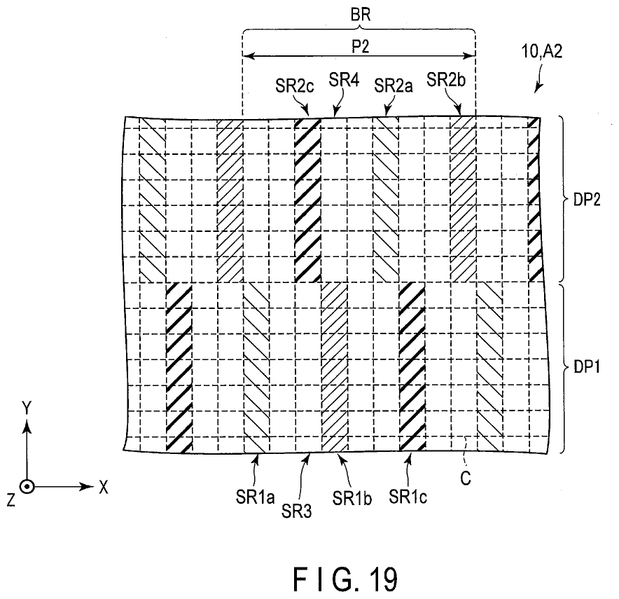

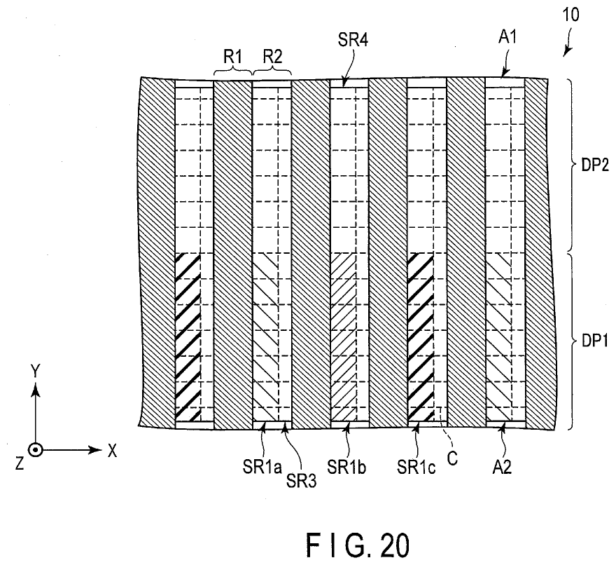

FIG. 18 is a plan view schematically showing an example of a structure that can be adopted for a first portion in a display according to a second embodiment of the present invention. FIG. 19 is a plan view schematically showing an example of a structure that can be adopted for a second portion in the display according to the second embodiment of the present invention. FIG. 20 is a plan view schematically showing a state in which the first portion shown in FIG. 18 and the second portion shown in FIG. 19 are overlapped with each other.

The display 10 shown in FIGS. 18 to 20 is the same as the display 10 described in the first embodiment except for the points described below.

Specifically, in the first portion A1 shown in FIG. 18, the ratio W1/W2 of the width W1 of the first region R1 to the width W2 of the second region R2 is 1.

In the second portion A2 shown in FIG. 19, the second period P2 of the arrangements of the band-shaped regions BR is different from the first period P1 of the arrangements of the first regions R1 or the second regions R2. Herein, the ratio P1/P2 between the first period P1 and the second period P2 is 1/3. The second period P2 is small enough to enable sub-regions SR1a to SR1c and SR3 to perform color display through subtractive color mixture and sub-regions SR2a to SR2c and SR4 to perform color display through subtractive color mixture.

One or more of the band-shaped regions BR include the sub-regions SR1a to SR1c, SR2a to SR2c, SR3 and SR4. Each of the sub-regions SR1a and SR2a displays a first color, each of the sub-regions SR1b and SR2b displays a second color different from the first color, each of the sub-regions SR1c and SR2c displays a third color different from the first and second colors, and each of the sub-regions SR3 and SR4 displays a fourth color different from the first to third colors.

In the first display portion DP1, the sub-regions SR1a to SR1c are arranged in the width direction with the sub-region SR3 interposed therebetween. In the second display portion DP2, the sub-regions SR2a to SR2c are arranged in the width direction with the sub-region SR4 interposed therebetween. The sub-regions SR1a to SR1c and SR2a to SR2c have the same widthwise dimension. Herein, the widths of the sub-regions SR1a to SR1c and SR2a to SR2c are ⅔ of the width W1 of the first region R1. The arrangements of the sub-regions SR1a to SR1c and the arrangements of the sub-regions SR2a to SR2c are shifted in phase by 4/9 of the second period P2.

One or more of the band-shaped regions BR may include only the sub-regions SR1a to SR1c and SR3. Specifically, one or more of the band-shaped regions BR may be entirely located in the first display portion DP1. Likewise, one or more of the band-shaped regions BR may include only the sub-regions SR2a to SR2c and SR4. Specifically, one or more of the band-shaped regions BR may be entirely located in the second display portion DP2.

As shown in FIG. 20, when the first portion A1 and the second portion A2 are overlapped with each other such that the first regions R1 face the sub-regions SR2a to SR2c, a difference occurs between the influence of the sub-regions SR1a to SR1c and SR3 on the display at the position of the first display portion DP1 and the influence of the sub-regions SR2a to SR2c and SR4 on the display at the position of the second display portion DP2. As a result, the latent image is visualized.

### Third Embodiment

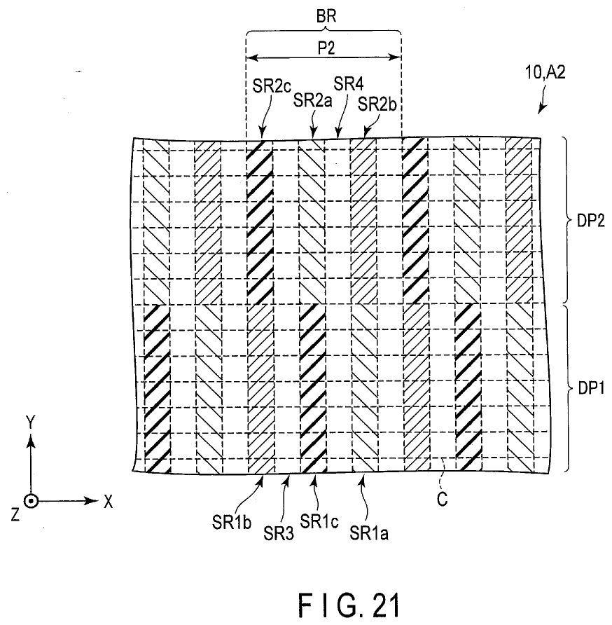

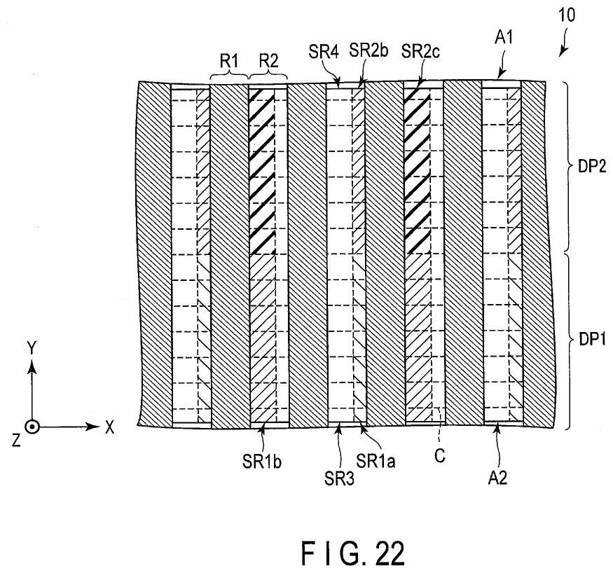

FIG. 21 is a plan view schematically showing an example of a structure that can be adopted for a second portion in a display according to a third embodiment of the present invention. FIG. 22 is a plan view schematically showing a state in which the first portion shown in FIG. 18 and the second portion shown in FIG. 21 are overlapped with each other.

The display 10 shown in FIGS. 21 and 22 is the same as the display 10 described in the second embodiment except for the points described below.

Specifically, in the second portion A2 shown in FIG. 21, the ratio P1/P2 between the first period P1 and the second period P2 is 1/2. The arrangements of the sub-regions SR1a to SR1c and the arrangements of the sub-regions SR1a and SR2b are shifted in phase by ⅓ of the second period P2. Specifically, in the band-shaped regions BR including the sub-regions SR1a to SR1c, SR2a to SR2c, SR3, and SR4, the sub-regions SR1a and SR2b are adjacent to each other in the longitudinal direction, the sub-regions SR1b and SR2c are adjacent to each other in the longitudinal direction, and the sub-regions SR1c and SR2a are adjacent to each other in the longitudinal direction.

When the first portion A1 and the second portion A2 are overlapped with each other as shown in FIG. 22, a difference occurs between the influence of the sub-regions SR1a to SR1c and SR3 on the display at the position of the first display portion DP1 and the influence of the sub-regions SR2a to SR2c and SR4 on the display at the position of the second display portion DP2. Specifically, the influence of the sub-region SR1c on the display at the position of the first display portion DP1 is the smallest, and the influence of the sub-region SR2a on the display at the position of the second display portion DP2 is the smallest. As a result, the latent image is visualized.

### Fourth Embodiment

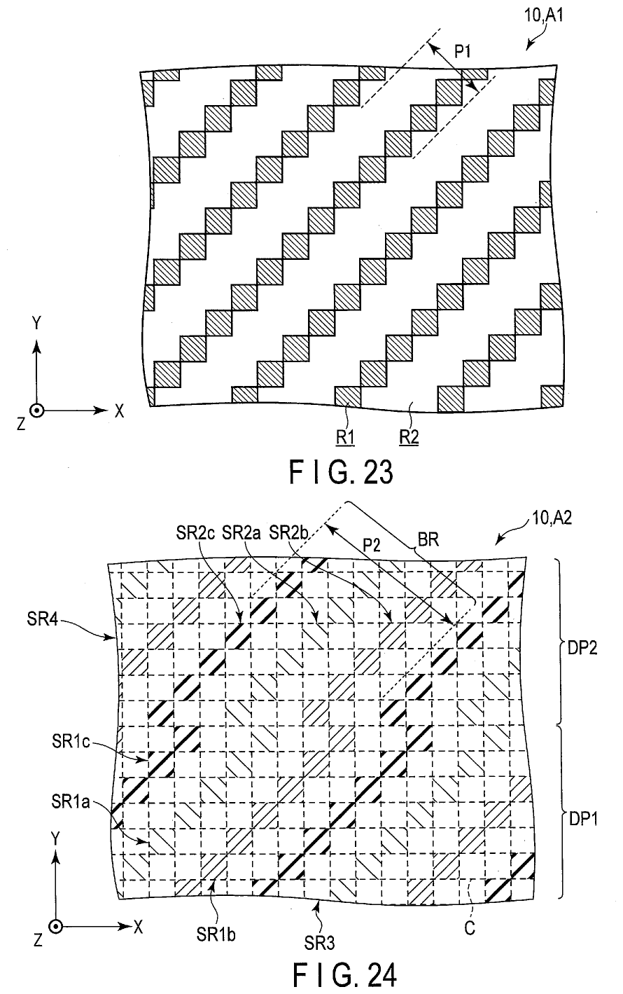

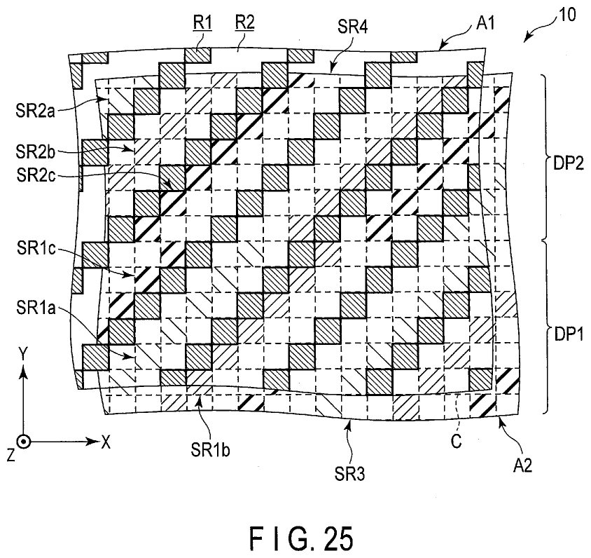

FIG. 23 is a plan view schematically showing an example of a structure that can be adopted for a first portion in a display according to a fourth embodiment of the present invention. FIG. 24 is a plan view schematically showing an example of a structure that can be adopted for a second portion in the display according to the fourth embodiment of the present invention. FIG. 25 is a plan view schematically showing a state in which the first portion shown in FIG. 23 and the second portion shown in FIG. 24 are overlapped with each other.

The display 10 shown in FIGS. 23 to 25 is the same as the display 10 described in the second embodiment except for the points described below.

Specifically, in the first portion A1 shown in FIG. 23, the first regions R1 and the second regions R2 each extend in a direction inclined with respect to the X direction, and are alternately arranged in the width direction thereof. Herein, it is assumed that the longitudinal directions of the first regions R1 and the second regions R2 form an angle of 45° with respect to the X direction, as an example.

In the second portion A2 shown in FIG. 24, the longitudinal directions of the band-shaped regions BR are inclined with respect to the X direction. Herein, it is assumed that the longitudinal directions of the band-shaped regions BR form an angle of 45° with respect to the X direction, as an example.

The arrangements of the sub-regions SR1a to SR1c and the arrangements of the sub-regions SR2a to SR2c are shifted in phase by 2/9 of the second period P2.

When the first portion A1 and the second portion A2 are overlapped with each other as shown in FIG. 25, a difference occurs between the influence of the sub-regions SR1a to SR1c and SR3 on the display at the position of the first display portion DP1 and the influence of the sub-regions SR2a to SR2c and SR4 on the display at the position of the second display portion DP2. Specifically, in each of the first display portion DP1 and the second display portion DP2, a color change occurs in the arrangement direction of the sub-regions in a period longer than the second period P2. If this period is sufficiently long, the change in color in each of the first display portion DP1 and the second display portion DP2 can be confirmed with the unaided eye. If the previous period is sufficiently long, a difference in color between the first display portion DP1 and the second display portion DP2 at the boundary therebetween can be confirmed. Therefore, the first display portion DP1 and the second display portion DP2 can be distinguished from each other. That is, the latent image is visualized.

### Fifth Embodiment

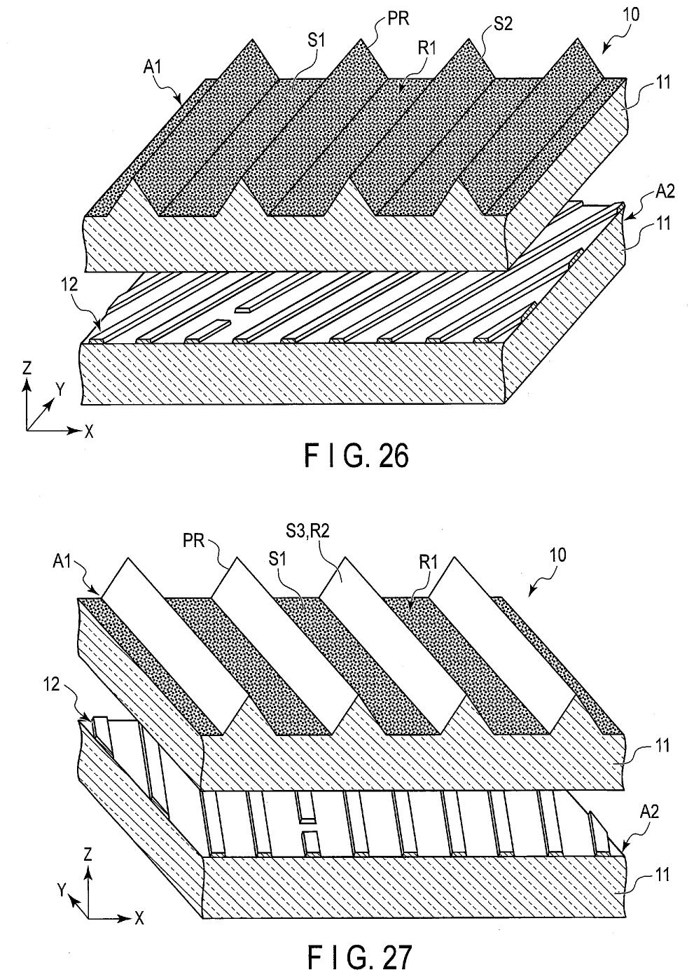

FIG. 26 is a partially cut-away perspective view schematically showing a display according to a fifth embodiment of the present invention. FIG. 27 is another partially cut-away perspective view of the display shown in FIG. 26.

The display 10 shown in FIGS. 26 and 27 is the same as the display 10 described in the first embodiment except for the points described below.

Specifically, the first portion A1 shown in FIGS. 26 and 27 has a flat first main surface and a second main surface, which is the back surface of the first main surface. The second main surface is provided with a plurality of protrusions PR each having a shape extending in the first direction, the Y direction in these figures, and regularly arranged in the second direction, the X direction in these figures.

The height of the protrusions PR is preferably from 10 μm to 500 μm. The width of the protrusions PR is preferably from 10 μm to 500 μm. An aspect ratio obtained by dividing the height by the width can be from 0.05 to 1.

The shape of the protrusions observed from a direction perpendicular to the first main surface, that is, the shape thereof in plan view, can be a straight line or a curved line. The curved line can be sinusoidal in shape. In addition, the protrusions PR may be parallel or non-parallel.

Each protrusion PR is a triangular prism whose one side surface is parallel to the first direction and the second direction and whose height direction is parallel to the first direction. A second partial region S2 and a third partial region S3, which will be described later, are another side surface and the remaining side surface of the triangular prism, respectively.

The adjacent protrusions PR are spaced apart from each other. On the second main surface of the first portion A1, a region between the two adjacent protrusions PR is a first partial region S1 having a shape extending in the first direction.

The surface of each of the protrusions PR includes the second partial region S2 and the third partial region S3 each having a shape extending in the first direction and arranged in the second direction. The second partial region S2 and the third partial region S3 face in different directions from each other. An angle formed by the second partial regions S2 with respect to a plane parallel to the first direction and the second direction is equal to an angle formed by the third partial regions S3 with respect to said plane.

Herein, the second partial regions S2 and the first partial regions S1 are first light-scattering surfaces and second light-scattering surfaces, respectively. Specifically, the first partial regions S1 and the second partial regions S2 each have randomly arranged concave portions or convex portions. The first partial regions S1 and the second partial regions S2 form the first regions R1. Herein, the third partial regions S3 are first flat surfaces. The third partial regions S3 form the second regions R2. An angle formed by the first flat surface with respect to the plane parallel to the first direction and the second direction is equal to an angle formed by the first light-scattering surface with respect to said plane.

In the second portion A2 shown in FIGS. 26 and 27, the printed layer 12 is formed of a plurality of linear portions. These linear portions are arranged in the width direction. The printed layer 12 includes a plurality of regions in which the linear portions differ from each other in one or more of the longitudinal direction, length, width, and arrangement pitch thereof. These regions form a latent image that is unidentifiable or difficult to identify when observed with the unaided eye without the intervention of the first portion A1 in the first state where the first portion A1 and the second portion A2 are spaced apart from each other.

This latent image becomes identifiable or easy to identify when observed under the conditions described below. That is, the latent image is visualized.

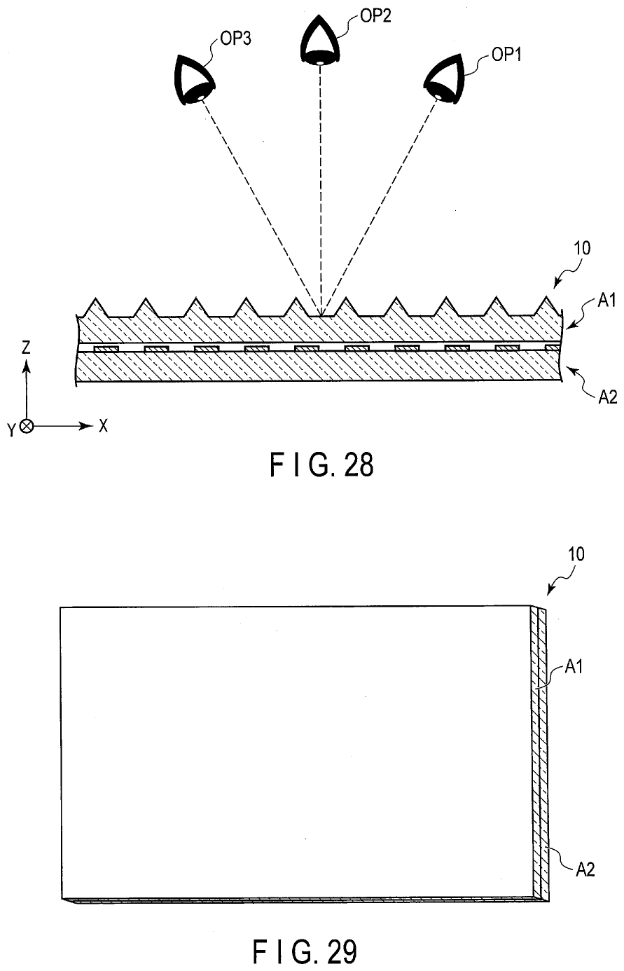

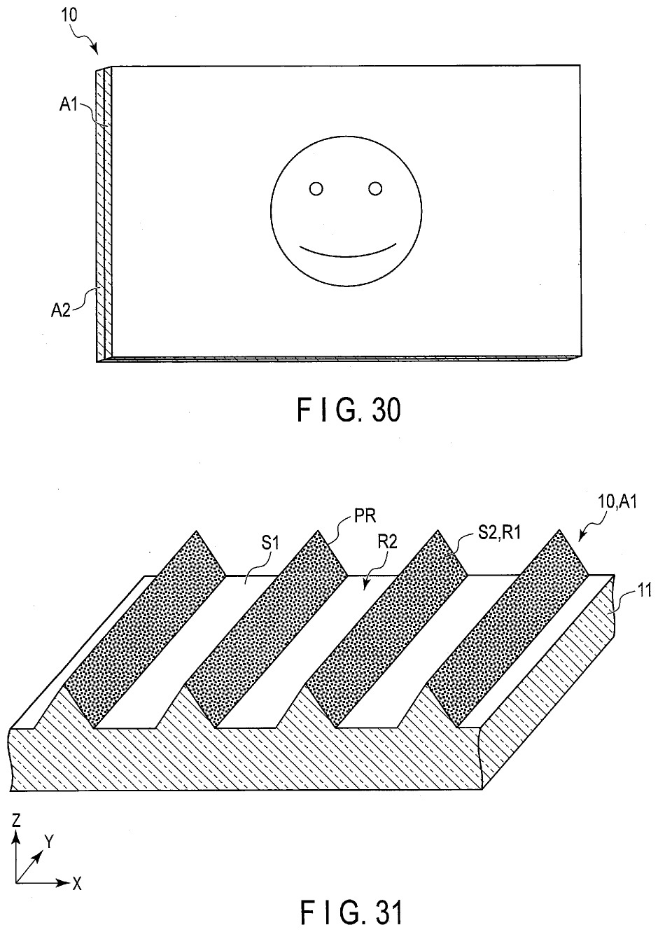

FIG. 28 is a view schematically showing a state in which an observer observes the display shown in FIGS. 26 and 27. FIG. 29 is a diagram showing an example of an image displayed in the second state by the display shown in FIGS. 26 and 27. FIG. 30 is a diagram showing another example of an image displayed in the second state by the display shown in FIGS. 26 and 27. Herein, it is assumed that in the second state where the first portion A1 and the second portion A2 overlap each other, the longitudinal direction of the protrusions PR intersects the longitudinal direction of the linear portions forming the printed layer 12, as shown in FIGS. 26 and 27.

In FIG. 28, the display 10 is in the second state. In FIG. 28, observers OP1 to OP3 observe the second portion A2 through the first portion A1 from the longitudinal direction of the protrusions PR, the direction perpendicular to the Y direction in this figure.

The observation direction of the observer OP1 falls within an angle range in which the third partial regions S3 are hidden by the second partial regions S2 and are invisible. The first partial regions S1 and the second partial regions S2 are light-scattering surfaces, as described above. Thus, under this observation condition, the third partial regions S3 do not contribute to the display, and the entire second main surface of the first portion A1 behaves as a light-scattering surface. As a result, it appears to the observer OP1 that the display 10 displays a white image as a whole, as shown in FIG. 29.

The observation direction of the observer OP2 is approximately perpendicular to the second main surface of the first portion A1. In this case, all of the first partial regions S1, the second partial regions S2, and the third partial regions S3 can contribute to the display. The first partial regions S1 and the second partial regions S2 are light-scattering surfaces, and the third partial regions S3 are flat surfaces, as described above. Thus, under this observation condition, the first portion A1 serves as a filter in which the second regions R2 corresponding to the third partial regions S3 have a higher transmittance than that of the first regions R1 corresponding to the first partial regions S1 and the second partial regions S2. As a result, the moiré effect enables or facilitates the identification of the latent image by the observer OP2. That is, the latent image is visualized, as shown in FIG. 30.

An angle formed by the observation direction of the observer OP3 with respect to the third partial regions S3 is larger than an angle formed by the observation direction of the observer OP2 with respect to the third partial regions S3. When this angle is increased, the contribution of the second partial regions S2 to the display is decreased, and the contribution of the third partial regions S3 to the display is increased. Therefore, the visual image is displayed more clearly.

### Sixth Embodiment

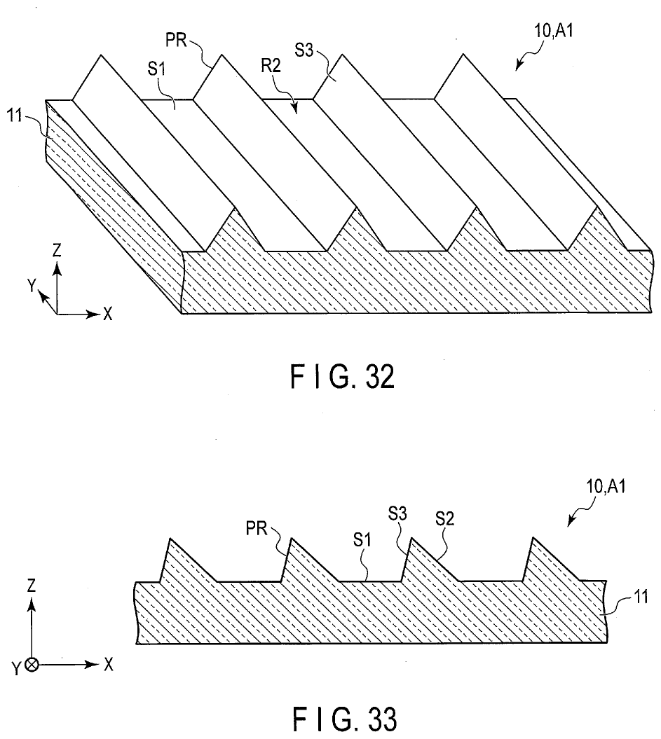

FIG. 31 is a partially cut-away perspective view schematically showing an example of a structure that can be adopted for a first portion in a display according to a sixth embodiment of the present invention. FIG. 32 is another partially cut-away perspective view of the structure shown in FIG. 31.

The display 10 shown in FIGS. 31 and 32 is the same as the display 10 described in the fifth embodiment except for the points described below.

Specifically, in the first portion A1 shown in FIGS. 31 and 32, the second partial regions S2 are the first light-scattering surfaces. More specifically, the second partial regions S2 have randomly arranged concave portions or convex portions. The second partial regions S2 form the first regions R1. The third partial regions S3 and the first partial regions S1 are the first flat surfaces and the second flat surfaces, respectively. The first partial regions S1 and the third partial regions S3 form the second regions R2. An angle formed by the first flat surfaces with respect to the plane parallel to the first direction and the second direction is equal to an angle formed by the first light-scattering surfaces with respect to said plane.

When observation is performed under the same conditions as described with reference to FIG. 28 except that the above-described display 10 is used, the display 10 displays an image described below.

The observation direction of the observer OP3 is approximately parallel to the second partial regions S2. Herein, the third partial regions S3 and the first partial regions S1 are the first flat surfaces and the second flat surfaces, respectively. Thus, under this observation condition, the second partial regions S2 hardly contribute to the display, and the first portion A1 behaves as if it is entirely transparent. Accordingly, the observer OP3 can see the image displayed by the printed layer 12 as it is.

The observation direction of the observer OP2 is approximately perpendicular to the second main surface of the first portion A1. In this case, all of the first partial regions S1, the second partial regions S2, and the third partial regions S3 can contribute to the display. The first partial regions S1 and the third partial regions S3 are flat surfaces, and the second partial regions S2 are light-scattering surfaces, as described above. Thus, under this observation condition, the first portion A1 serves as a filter in which the second regions R2 corresponding to the first partial regions S1 and the third partial regions S3 have a higher transmittance than that of the first regions R1 corresponding to the second partial regions S2. As a result, the moiré effect enables or facilitates the identification of the latent image by the observer OP2.

An angle formed by the observation direction of the observer OP1 with respect to the second partial regions S2 is larger than an angle formed by the observation direction of the observer OP2 with respect to the second partial regions S2. When this angle is increased, the contribution of the third partial regions S3 to the display is decreased, and the contribution of the second partial regions S2 to the display is increased. Therefore, the visual image is displayed more clearly.

### Seventh Embodiment

FIG. 33 is a cross-sectional view schematically showing an example of a structure that can be adopted for a first portion in a display according to an eighth embodiment of the present invention.

The display 10 shown in FIG. 33 is the same as the display 10 described in the fifth embodiment except for the points described below.

Specifically, in the first portion A1 shown in FIG. 33, an angle formed by the second partial regions S2 with respect to a plane parallel to the first direction and the second direction is different from an angle formed by the third partial regions S3 with respect to said plane. More specifically, an angle formed by the second partial regions S2 with respect to said plane is smaller than an angle formed by the third partial regions S3 with respect to said plane. The second partial regions S2 are first flat surfaces, the third partial regions S3 are first light-scattering regions, and the first partial regions S1 are second light-scattering surfaces.

When the above-described structure is adopted, the angle range in which the white image described with reference to FIG. 29 is observed becomes larger, as compared to the case where the structure described with reference to FIGS. 26 and 27 is adopted. Also, when said structure is adopted, the angle range in which the visual image described with reference to FIG. 30 is observed becomes smaller, as compared with the case where the structure described with reference to FIGS. 26 and 27 is adopted.

When a structure in which the angle formed by the second partial regions S2 with respect to the plane parallel to the first direction and the second direction is larger than the angle formed by the third partial regions S3 with respect to said plane is adopted, the angle range in which the white image described with reference to FIG. 29 is observed becomes smaller, as compared to the case where the structure described with reference to FIGS. 26 and 27 is adopted. Also, when said structure is adopted, the angle range in which the visual image described with reference to FIG. 30 is observed becomes larger, as compared to the case where the structure described with reference to FIGS. 26 and 27 is adopted.

### Eighth Embodiment

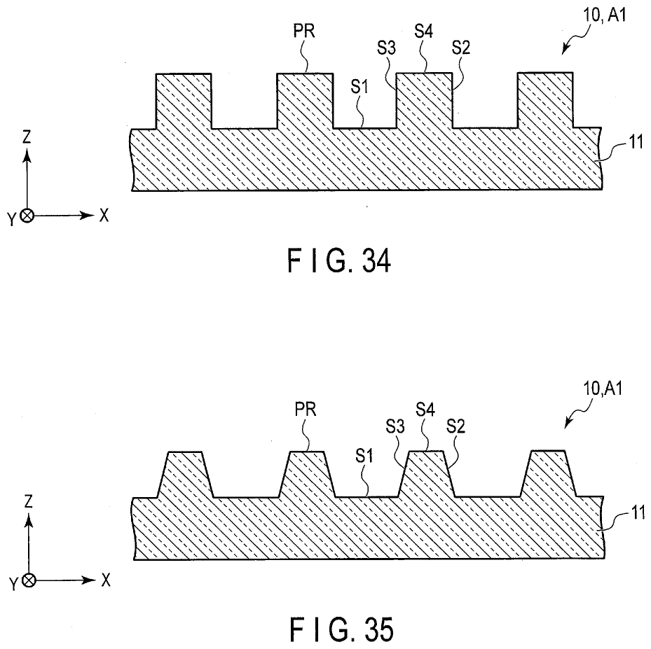

FIG. 34 is a cross-sectional view schematically showing an example of a structure that can be adopted for a first portion in a display according to an eighth embodiment of the present invention.

The display 10 shown in FIG. 34 is the same as the display 10 described in the fifth embodiment except for the points described below.

Specifically, in the first portion A1 shown in FIG. 34, each of the protrusions PR is a quadrangular prism whose one side surface is parallel to the first direction and the second direction and whose height direction is parallel to the first direction. Herein, the cross section perpendicular to the height direction of each quadrangular prism is a right-angled quadrangle. The two side surfaces of each quadrangular prism perpendicular to the second direction, that is, the two side surfaces of each protrusion PR, are the second partial region S2 and the third partial region S3. One of the side surfaces of each quadrangular prism parallel to the second direction, that is, the upper surface of each protrusion PR, is the fourth partial region S4.

The fourth partial regions S4 and the first partial regions S1 are the first light-scattering surfaces and the second light-scattering surfaces, respectively. Specifically, the first partial regions S1 and the fourth partial regions S4 have randomly arranged concave portions or convex portions. The first partial regions S1 and the fourth partial regions S4 form the first regions R1. The second partial regions S2 and the third partial regions S3 are the first flat surfaces and the second flat surfaces, respectively. The second partial regions S2 and the third partial regions S3 form the second regions R2.

When observation is performed under the same conditions as described with reference to FIG. 28 except that the above-described display 10 is used, the display 10 displays an image described below.

The observation direction of the observer OP2 is approximately parallel to the second partial regions S2 and the third partial regions S3. Herein, the fourth partial regions S4 and the first partial regions S1 are the first light-scattering surfaces and the second light-scattering surfaces, respectively. Thus, under this observation condition, the second partial regions S2 and the third partial regions S3 hardly contribute to the display, and the first portion A1 behaves as if it is entirely a light-scattering layer. Accordingly, the observer OP2 can see the white image described with reference to FIG. 29.

The observation direction of the observer OP1 is oblique to the second partial regions S2. In this case, the first portion A1 serves as a filter in which the regions corresponding to the second partial regions S2 have a higher transmittance than that of the other regions. As a result, the moiré effect enables or facilitates the identification of the latent image by the observer OP1.

The observation direction of the observer OP3 is oblique to the third partial region S3. In this case, the first portion A1 serves as a filter in which the regions corresponding to the third partial regions S3 have a higher transmittance than that of the other regions. As a result, the moiré effect enables or facilitates the identification of the latent image by the observer OP3.

### Ninth Embodiment

FIG. 35 is a cross-sectional view schematically showing an example of a structure that can be adopted for a first portion in a display according to a ninth embodiment of the present invention.

The display 10 shown in FIG. 35 is the same as the display 10 described in the fifth embodiment except for the points described below.

Specifically, in the first portion A1 shown in FIG. 35, each of the protrusions PR is a quadrangular prism whose one side surface is parallel to the first direction and the second direction and whose height direction is parallel to the first direction. Herein, the cross section perpendicular to the height direction of each quadrangular prism is a trapezoid having an upper base corresponding to the upper surfaces of the protrusions PR and a lower base corresponding to the bottom surfaces of the protrusions PR. The two side surfaces of each quadrangular prism corresponding to the legs of a trapezoid, that is, the two side surfaces of each protrusion PR, are the second partial region S2 and the third partial region S3. In addition, the side surface of each quadrangular prism corresponding to the upper base of a trapezoid, that is, the upper surface of each protrusion PR, is the fourth partial region S4.

A combination of the second partial region S2 and the fourth partial region S4 is a first light-scattering surface, and the first partial region S1 is a second light-scattering surface. Specifically, the first partial regions S1, the second partial regions S2, and the fourth partial regions S4 have randomly arranged concave portions or convex portions. The first partial regions S1, the second partial regions S2, and the fourth partial regions S4 form the first regions R1. The third partial regions S3 are the first flat surfaces. The third partial regions S3 form the second regions R2.

When observation is performed under the same conditions as described with reference to FIG. 28 except that the above-described display 10 is used, the display 10 displays an image described below.

In the observation direction of the observer OP1, the third partial regions S3 hardly contribute to the display, and the first portion A1 behaves as if it is entirely a light-scattering layer. Accordingly, the observer OP3 can see the white image described with reference to FIG. 29.

In the observation direction of the observer OP2, the third partial regions S3 may make a small contribution to display. Thus, under this observation condition, the first portion A1 serves as a filter in which the second regions R2 corresponding to the third partial regions S3 have a higher transmittance than that of the first regions R1 corresponding to the first partial regions S1, the second partial regions S2, and the fourth partial regions S4. As a result, the moiré effect enables or facilitates the identification of the latent image by the observer OP2.

An angle formed by the observation direction of the observer OP3 with respect to the third partial regions S3 is larger than an angle formed by the observation direction of the observer OP2 with respect to the third partial regions S3. When this angle is increased, the contribution of the third partial regions S3 to the display increases. Therefore, the visual image is displayed more clearly.

### Tenth Embodiment

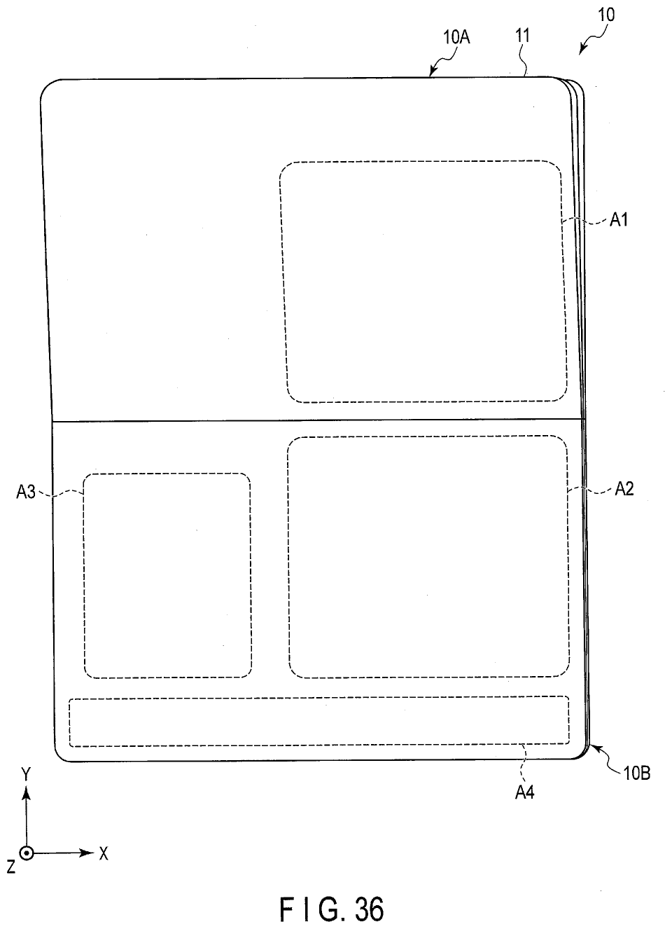

FIG. 36 is a plan view schematically showing a display according to a tenth embodiment of the present invention. FIG. 17 shows a booklet in an opened state.

The display 10 shown in FIG. 36 is a booklet. Herein, the display 10 is a passport. The display 10 may be a different article, for example, a passbook such as a deposit passbook.

The display 10 includes one or more sheets 10A and a cover 10B. Herein, it is assumed that the number of sheets 10A included in the display 10 is two or more, as an example.

The sheets 10A are stacked on top of each other. Each sheet 10A has an approximately rectangular shape. More specifically, the shape of each sheet 10A is a rectangle with rounded corners. The bundle of sheets 10A is folded in two at an intermediate position between a pair of short sides of the sheets. Each of the two separate portions of the sheets 10A created by the folding line is a page portion in which one page is allocated to one surface and another page is allocated to the other surface.

The cover 10B is folded in two. The cover 10B and the bundle of sheets 10A are overlapped with each other so that the positions of the folding lines coincide with each other and that the bundle of sheets 10A is sandwiched by the cover 10B with the display 10 closed. The cover 10B and the bundle of sheets 10A are integrated with each other by, for example, binding them at the position of the folding lines thereof.

One of the sheets 10A includes the first portion A1 on one of the page portions. Among the sheets 10A, a sheet that includes a page portion that comes into contact with a page portion including the first portion A1 when the display 10 is closed, includes the second portion A2 in said page portion. Specifically, the first portion A1 is included in one of a pair of page portions adjacent to each other with the display 10 closed, and the second portion A2 is included in the other page portion. The first portion A1 and the second portion A2 are arranged so as to overlap with each other with the display 10 closed. The first portion A1 and the second portion A2 have the same structure as those of the first portions A1 and the second portions A2 of the displays 10 according to the first to ninth embodiments, respectively.

The first portion A1 and the second portion A2 may be provided in one and the other of a pair of adjacent sheets 10A, respectively. Alternatively, the first portion A1 and the second portion A2 may be provided in the same sheet 10A. Alternatively, the second portion A2 may be provided on the back surface of the cover 10B, and the first portion A1 may be provided in the sheet 10A adjacent to the second portion A2 with the display 10 closed. Herein, it is assumed that the first portion A1 and the second portion A2 are provided in one and the other of a pair of adjacent sheets 10A, respectively, as an example.

The page portion provided with the second portion A2 is further provided with a third portion A3 and a fourth portion A4. The third portion A3 is a portion in which a face photograph is recorded. The fourth portion A4 is a portion in which information that allows for optical character recognition is recorded, for example, by printing. The page provided with the third portion A3 and the fourth portion A4 is a so-called datapage.

The third portion A3 and the fourth portion A4 may be provided in another page portion. For example, the third portion A3 and the fourth portion A4 can be provided in the page portion having the first portion A1. The third portion A3 and the fourth portion A4 are preferably provided in a page portion adjacent to the cover 10B when the display 10 is closed.

If the sheet 10A having the first portion A1 includes a polymer sheet as a substrate, the carrier 11 can be used as the polymer sheet. Alternatively, if the sheet 10A having the first portion A1 includes a piece of paper as a substrate, a window can be provided in the piece of paper to arrange the first portion A1 at the position of the window.

Likewise, if the sheet 10A having the second portion A2 includes a polymer sheet as a substrate, the carrier 11 can be used as the polymer sheet. Alternatively, if the sheet 10A having the second portion A2 includes a piece of paper as a substrate, a window can be provided in the piece of paper to arrange the second portion A2 at the position of the window.

In the sheet 10A having neither the first portion A1 nor the second portion A2, either a polymer sheet or a paper piece may be used as the substrate. However, it is preferable to use a polymer sheet as the substrate in the sheet 10A that includes the datapage.

An integrated circuit (IC) chip having individual information recorded thereon, an antenna that enables non-contact communication between the IC chip and an external device, or the like may be built into any of the sheets 10A. If an IC chip or an antenna is to be built into the page portion having the first portion A1, they are built into a portion other than the first portion A1. If an IC chip or an antenna is to be built into the page portion having the second portion A2, they are built into a portion other than the second portion A2.

By turning pages, the display 10 described above can be deformed between the first state in which the first portion A1 and the second portion A2 are spaced apart from each other and the second state in which the first portion A1 and the second portion A2 overlap each other. Also, the display 10 allows the second portion A2 to be observed without the intervention of the first portion A1 in the first state, and the second portion A2 to be observed through the first portion A1 in the second state. Therefore, the display 10 can visualize the latent image through a simple operation of turning pages.

In the display 10, the latent image preferably displays individual information when visualized. The individual information is information that allows the display 10 to be distinguished from one or more other displays. According to an example, the individual information is personal information such as date of birth and name. According to another example, the individual information is issuance information such as an issuance date, an issuance number, and an expiration date. According to still another example, the individual information is a combination of personal information and issuance information. With the latent image displaying individual information when visualized, the deterrence against forgery and alteration is enhanced.

### <Modifications>

Various modifications can be made to the above-described embodiments.

For example, in the third and fourth embodiments, the first period P1 is twice the size of the cells C in the arrangement direction of the sub-regions. The first period P1 may deviate from twice the size of the cells C in the arrangement direction of the sub-regions. In this case, the difference between the first period P1 and twice the size of the cells C in the X direction is, for example, within a range of ±25% with respect to twice the size of the cells C in the X direction.

When the first period P1 is deviated from twice the size of the cells C in the X direction, the color of the visual image changes in the arrangement direction of the sub-regions or in the X direction at the positions of the first display portion DP1 and the second display portion DP2. For example, the color of the visual image appears to be rainbow colored at the positions of the first display portion DP1 and the second display portion DP2.

In this case, the arrangement order of the sub-regions SR1a to SR1c and the arrangement order of the sub-regions SR2a to SR2c may be reversed. This causes the order of the color change of the visual image at the position of the first display portion DP1 and the order of the color change of the visual image at the position of the second display portion DP2 to be reversed. Therefore, the visual image is more easily identified.

The structures described for the first portions A1 of the displays 10 in the fifth to ninth embodiments may be adopted for the first portions A1 of the displays 10 according to the first to fourth embodiments. The structures described for the second portions A2 of the displays 10 in the fifth to ninth embodiments may be adopted for the second portions A2 of the displays 10 according to the first to fourth embodiments. Such combinations may be adopted for the first portion A1 and the second portion A2 of the display 10 according to the tenth embodiment.

The embodiments of the invention are a group of embodiments based on a single original invention. The aspects of the invention are also a group of aspects based on a single invention. Thus, the features of the invention can be combined without being limited to the above-described combinations. Accordingly, the features, configurations, aspects, and embodiments of the invention can be combined, and the combinations thereof can exhibit cooperative functions and synergistic effects.

Although the best mode for carrying out the invention has been described above with reference to the accompanying drawings, the scope of the disclosure of the invention is not limited to the illustrated or described embodiments, and can include all embodiments that bring about an effect equivalent to the object of the invention. Furthermore, the scope of the present disclosure is not limited to the features of the invention defined by the claims, but may also include each and every disclosed feature and every combination of the features.

### Examples

### <Production of Display>

The display 10 described in the third embodiment was produced as described below.

First, a transparent film (product name: OHP film (for color LBP & color PPC), distributor: KOKUYO Co., Ltd., material: R-PET film, thickness: 0.10 mm) was prepared as the carrier 11. The printed layer 12 was formed on the carrier 11 using a laser printer (MICROLINE (registered trademark) VINCH C931dn, manufactured by Oki Data Co., Ltd.). The second portion A2 was thus formed.

The printed layer 12 adopted the following structure. Specifically, the portions of the printed layer 12 corresponding to the sub-regions SR1a and SR2a were cyan-colored, the portions of the printed layer 12 corresponding to the sub-regions SR1b and SR2b were magenta-colored, and the portions of the printed layer 12 corresponding to the sub-regions SR1c and SR2c were yellow-colored. The portions of the printed layer 12 arranged to correspond to the cells C were formed to have a dimension of 85 μm in the X direction. The pitch of the arrangement of these portions in the X direction was 130 μm. The pitch of the arrangement of the sub-regions SR1a to SR1c and the pitch of the arrangement of the sub-regions SR2a to SR2c were 380 μm.

Next, a mother plate was prepared by the method described with reference to FIGS. 4 and 5. Herein, the mask layer 32 was formed by gravure offset printing. The mask layer 32 was formed in a striped pattern in which linear portions parallel to each other were arranged in the width direction. The pitch of the arrangement of the linear portions was 400 μm, and the width of the linear portions was 200 μm. The mold substrate 31 provided with the mask layer 32 was subjected to a sandblast treatment to form an uneven structure in the portion of the mold substrate 31 not covered with the mask layer 32. The mask layer 32 was removed by wiping with a waste cloth soaked with a solvent.

The mother plate thus prepared was fitted into a cylinder to obtain the embossing cylinder 20 shown in FIG. 3. Thermal embossing was performed on the carrier 11 using the embossing cylinder 20, whereby the first portion A1 was formed.

The display 10 was thus produced. Herein, the shape of the display 10 was rectangular, as shown in FIG. 1. The first portion A1 and the second portion A2 were formed to be symmetrical with respect to the straight line L.

When the second portion A2 was observed with the unaided eye with the display 10 unfolded, that is, without the intervention of the first portion A1, the first display portion DP1 and the second display portion DP2 could not be distinguished from each other. Next, the display 10 was folded in two at the position of the straight line L as a folding line, and the second portion A2 was observed with the unaided eye through the first portion A1. As a result, the first display portion DP1 and the second display portion DP2 appeared in different colors, and the latent image was visualized.

The objects specified by the terms “portion”, “display portion”, “element”, “region”, “layer”, “substrate”, “pixel”, “surface”, “display”, “carrier”, “article”, and “printed layer” as used in the present disclosure are physical entities. A physical entity can refer to a physical form or a spatial form surrounded by a substance. A physical entity can be characterized by its material, physical property, physical quantity, psychophysical quantity, location, shape, contour, size, width, periodicity of location, statistics, recorded information, recorded data, recorded code, readable information, readable data, readable code, ability, performance, appearance, color, spectrum, forming/displaying image, processing method, sensing method, verifying method, and determining method. Also, due to the characteristics of the physical entity, the physical entity can have a particular function. A set of physical entities with specific functions can exhibit a synergistic effect due to the functions of those physical entities.

Reference should be made to the drawings where necessary when interpreting terms, configurations, characteristics, aspects, and embodiments. The matters that can be derived directly and unambiguously from the drawings should be the basis for the amendment in the same way as from the text.

The terms used in the present disclosure and especially in the claims are generally intended as “open” terms (e.g., the term “comprise/comprising” should be interpreted as “have/having at least”, and the term “include/including” should be interpreted as “include/including, but not limited to”, etc.). Further, no specific number is intended to be present unless a specific number is explicitly recited in a claim. For example, as an aid to understanding, the claims can include use of the introductory phrases “at least one” and “one or a plurality of” to introduce claim recitations. However, the use of such phrases should not be construed to limit a particular claim, including a claim incorporating a recitation with the indefinite article “a” or “an”, to an embodiment including only one such recitation based on said recitation with the indefinite article. The phrases “one or more” or “at least one” should be construed to mean “one, or one or more”.

### REFERENCE SIGNS LIST

10. Display
11. Carrier
12. Printed layer
20. Embossing cylinder
21. Metal substrate
31. Mold substrate
32. Mask layer
A1. First portion
A2. Second portion
A3. Third portion
A4. Fourth portion
BR. Band-shaped region
C. Cell
DP1. First display portion
DP2. Second display portion
OP1. Observer
OP2. Observer
OP3. Observer
P1. First period
P2. Second period
R1. First region
R2. Second region
S1. First partial region
S2. Second partial region
S3. Third partial region
S4. Fourth partial region
SR1. Sub-region
SR1a. Sub-region
SR1b. Sub-region
SR1c. Sub-region
SR2. Sub-region
SR2a. Sub-region
SR2b. Sub-region
SR2c. Sub-region
SR3. Sub-region
SR4. Sub-region
W1. Width
W2. Width

1. A display comprising a first portion and a second portion and being deformable between a first state in which the first portion and the second portion are spaced apart from each other and a second state in which the first portion and the second portion overlap each other, wherein
the first portion includes first regions and second regions each having a shape extending in a first direction and alternately and regularly arranged in a second direction intersecting the first direction, each of the first regions being a light-permeable region provided with a light-deflecting structure having a light-deflecting property, and each of the second regions being a transparent region having a flat front surface and a flat back surface, and
a latent image is recorded in the second portion, the latent image being unidentifiable or difficult to identify when observed without an intervention of the first portion in the first state and being identifiable or easy to identify when observed through the first portion in the second state, and
the light-deflecting structure includes a lenticule.

2. The display according to claim 1, wherein the front surface and the back surface are parallel to each other.

3. The display according to claim 1, comprising a carrier made of a polymer.

4. The display according to claim 1, wherein the first regions, the second regions, or protrusions are arranged in a period within a range of 40 μm to 1000 μm.

5. The display according to claim 1, wherein the second portion is formed of a plurality of band-shaped regions regularly arranged in a width direction, and the latent image is recorded in the plurality of band-shaped regions.

6. The display according to claim 5, wherein
the second portion includes first and second display portions adjacent to each other,
one or more of the plurality of band-shaped regions each include first to fourth sub-regions, and
in each of the one or more of the plurality of band-shaped regions,
each of the first and second sub-regions displays a first color,
each of the third and fourth sub-regions displays a second color different from the first color,
the first and third sub-regions are arranged in the width direction in the first display portion,
the second and fourth sub-regions are arranged in the width direction in the second display portion, and
the first and second sub-regions are at different positions in the width direction.

7. The display according to claim 5, wherein
the second portion includes first and second display portions adjacent to each other,
one or more of the plurality of band-shaped regions each include first to sixth sub-regions, and
in each of the one or more of the plurality of band-shaped regions,
each of the first and second sub-regions displays a first color,
each of the third and fourth sub-regions displays a second color different from the first color,
each of the fifth and sixth sub-regions displays a third color different from the first and second colors,
the first, third, and fifth sub-regions are arranged in the width direction in the first display portion,
the second, fourth, and sixth sub-regions are arranged in the width direction in the second display portion,
the first and second sub-regions are at different positions in the width direction,
the third and fourth sub-regions are at different positions in the width direction, and
the fifth and sixth sub-regions are at different positions in the width direction.

8. The display according to claim 7, wherein in each of the one or more of the plurality of band-shaped regions, all of the first, third, and fifth sub-regions are at a position different from the positions of the second, fourth, and sixth sub-regions in the width direction.

9. The display according to claim 7, wherein in each of the one or more of the plurality of band-shaped regions, the first and fourth sub-regions are at a same position in the width direction, the second and fifth sub-regions are at a same position in the width direction, and the third and sixth sub-regions are at a same position in the width direction.

10. The display according to claim 6, wherein the first regions or protrusions are arranged in a first period P1, the plurality of band-shaped regions are arranged in a second period P2, and a ratio P1/P2 of the first period P1 to the second period P2 is an integer.

11. The display according to claim 6, wherein the first regions or protrusions are arranged in a first period P1, the plurality of band-shaped regions are arranged in a second period P2, and a ratio P1/P2 of the first period P1 to the second period P2 is deviated from integers.

12. The display according to claim 6, wherein the display has a rectangular shape, and both the second direction and the width direction are parallel to or perpendicular to a long side of the display.

13. The display according to claim 6, wherein the display has a rectangular shape, and both the second direction and the width direction are inclined with respect to a long side of the display.

14. The display according to claim 1, wherein the display is in a sheet form or a film form, the first state is a state in which the display is unfolded, and the second state is a state in which the display is folded or bent.

15. The display according to claim 14, wherein the display has a rectangular shape, and the first and second portions are arranged to be in the second state when the display is folded or bent such that an edge along one short side overlaps an edge along another short side.

16. The display according to claim 1, wherein the display is a booklet.

17. The display according to claim 1, wherein the latent image is recorded as print on the second portion.

18. A display method comprising causing the display according to claim 1 to be in the second state.
